(19) United States
(12) Patent Application Publication
(10) Pub. No.: US 2026/0288842 A1
(43) Pub. Date: Sep. 24, 2026

(54) SYSTEM

(71) Applicant: SoftBank Group Corp., Tokyo (JP)

(72) Inventor: Kazuhiro NOMI, Tokyo (JP)

(73) Assignee: SoftBank Group Corp., Tokyo (JP)

(21) Appl. No.: 19/560,271

(22) Filed: Mar. 9, 2026

(30) Foreign Application Priority Data
Mar. 19, 2025 (JP) 2025-044900

(51) Int. Cl. G06F 16/34; G06N 3/0475; G06V 30/12

(52) U.S. Cl. CPC G06F 16/345; G06N 3/0475; G06V 30/12

(57) ABSTRACT

A system includes a processor that is configured to collect image data by using a scanner or a digital camera in order to acquire information from a resume or a work history document, convert character information included in the collected image data into digital text data by using optical character recognition, and generate a prompt for instructing a generative artificial intelligence model to summarize information from structured data, input the prompt into the generative artificial intelligence model, and summarize the information by using the generative artificial intelligence model.

### CROSS-REFERENCE TO RELATED APPLICATION

This application is based on and claims priority under 35 USC 119 from Japanese Patent Application No. 2025-044900 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recruitment and interview processes rely heavily on manual operations for handling resumes and work history documents, extracting and structuring information, and creating interview records. In particular, when resumes and work history documents are provided as paper documents or as image data, an operator is required to manually read the contents, re-enter textual information into a system, classify and format the data, and then summarize the candidate's background. Such manual work is time-consuming, prone to human error, and difficult to scale when the number of applicants is large.

Furthermore, conventional systems do not adequately utilize generative artificial intelligence models to automatically summarize information from structured data derived from resumes and work history documents. As a result, in many organizations, the interviewer must manually review the structured data and create summaries or key points by hand, which increases the cognitive burden on the interviewer and can lead to omission of important information.

In addition, during interviews, the creation of post-interview records is often performed manually based on handwritten notes or recollection of the interviewer. Even when audio recording is performed, the transcription and structuring of recorded audio into useful text records is frequently done by human operators. This manual transcription process is time-intensive, susceptible to transcription errors, and often delays the availability of interview records for hiring decisions.

Accordingly, there is a need for a system that can seamlessly: (i) capture resume and work history information as image data, (ii) convert the image data into digital text by optical character recognition, (iii) format and store the converted text as structured data, (iv) utilize generative artificial intelligence to automatically generate summaries from the structured data, and (v) convert audio recorded during interviews into text and automatically generate post-interview records. Such a system would reduce the amount of manual work, improve accuracy and consistency of candidate information management, and accelerate the overall recruitment and interview workflow.

### SUMMARY

In order to solve the above-described problems, an aspect of the present invention provides a system comprising a processor, wherein the processor is configured to collect image data by using a scanner or a digital camera in order to acquire information from a resume or a work history document. The processor converts character information included in the collected image data into digital text data by using optical character recognition. The processor further generates a prompt for instructing a generative artificial intelligence model to summarize information from structured data, inputs the prompt into the generative artificial intelligence model, and summarizes the information by using the generative artificial intelligence model.

In one embodiment, the processor is configured to format the converted character information into a predetermined format and store the formatted information as structured data in a database. By doing so, the system automatically transforms unstructured text obtained from image-based resumes and work history documents into structured data that can be effectively processed by downstream applications, including the generative artificial intelligence model.

In another embodiment, the processor is configured to convert audio data recorded during an interview into text by using speech recognition software and automatically generate a post-interview record based on the converted text. The processor may apply natural language processing or formatting rules to the converted text in order to produce a coherent and usable interview record, such as a meeting minute or summary of key points discussed during the interview.

By combining these functions, the system automatically digitizes and structures information from resumes and work history documents, leverages a generative artificial intelligence model to summarize candidate information, and automatically generates post-interview records from recorded audio. Consequently, the system reduces manual data entry and transcription efforts, improves the reliability and consistency of candidate-related information, and enhances the efficiency of the recruitment and interview process.

The term “processor” refers to one or more hardware processing units, such as a central processing unit (CPU), a graphics processing unit (GPU), a digital signal processor (DSP), or any combination thereof, that executes instructions to perform the operations of the system.

The term “scanner” refers to an image acquisition device that optically reads a physical document, such as a paper resume or work history document, and converts the document into electronic image data.

The term “digital camera” refers to an image capture device, including a standalone camera, a smartphone camera, or a tablet camera, that captures an image of a document and outputs the image as electronic image data.

The term “image data” refers to electronic data representing a visual image of a document, such as a resume or work history document, in a raster or vector format including, but not limited to, JPEG, PNG, TIFF, or PDF formats.

The term “resume” refers to a document that describes a person's personal information, educational background, work experience, skills, and related information for the purpose of job application.

The term “work history document” refers to a document, such as a curriculum vitae (CV) or a detailed employment record, that describes past employment, job roles, responsibilities, achievements, and other career-related information of a person.

The term “character information” refers to textual content, including letters, numbers, symbols, and punctuation marks, that is visually represented in the image data of a resume or work history document.

The term “digital text data” refers to machine-readable textual data obtained by converting character information from image data into an electronic text format that can be processed, stored, and analyzed by a computer system.

The term “optical character recognition” refers to a computational technique for analyzing image data to detect and recognize characters and words, and for converting such detected characters and words into corresponding digital text data.

The term “generative artificial intelligence model” refers to a machine learning model, such as a neural network-based language model, that is configured to generate or transform text or other content based on input data or prompts.

The term “prompt” refers to an input instruction or text provided to a generative artificial intelligence model, which specifies a task, such as summarizing information from structured data, and guides the generative artificial intelligence model in producing an output.

The term “structured data” refers to data that is organized according to a predefined schema or format, including fields such as names, dates, company names, job titles, and skills, enabling efficient storage, retrieval, and processing by a database or application.

The term “summarize information” refers to the operation of generating a condensed representation of information that captures key points, essential details, or main ideas from source data, such as structured data derived from resumes or work history documents.

The term “predetermined format” refers to a defined data structure or layout, including specific fields, data types, and ordering rules, that is used to arrange converted character information for consistent storage and processing.

The term “database” refers to an organized collection of data stored in one or more storage devices, managed by database management software, and accessible for storing, retrieving, updating, and querying structured data.

The term “audio data” refers to electronic data representing sound, including voice signals recorded during an interview, in a format such as WAV, MP3, or another digital audio format.

The term “speech recognition software” refers to software, including cloud-based or on-premise automatic speech recognition (ASR) systems, that analyzes audio data to detect spoken words and converts the spoken words into corresponding digital text data.

The term “post-interview record” refers to a document or electronic data object generated after an interview, which includes at least a text representation of the conversation or key points of the interview, and which is used for evaluation, documentation, or decision-making in a recruitment process.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

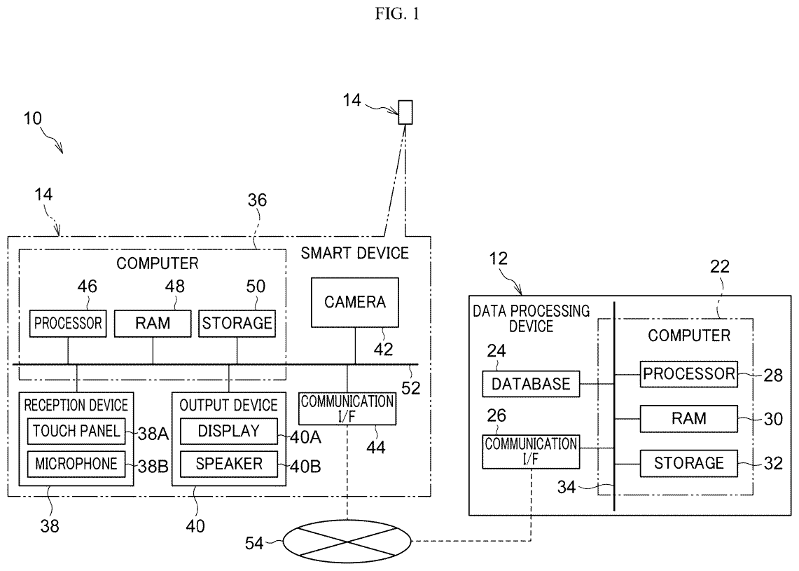

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

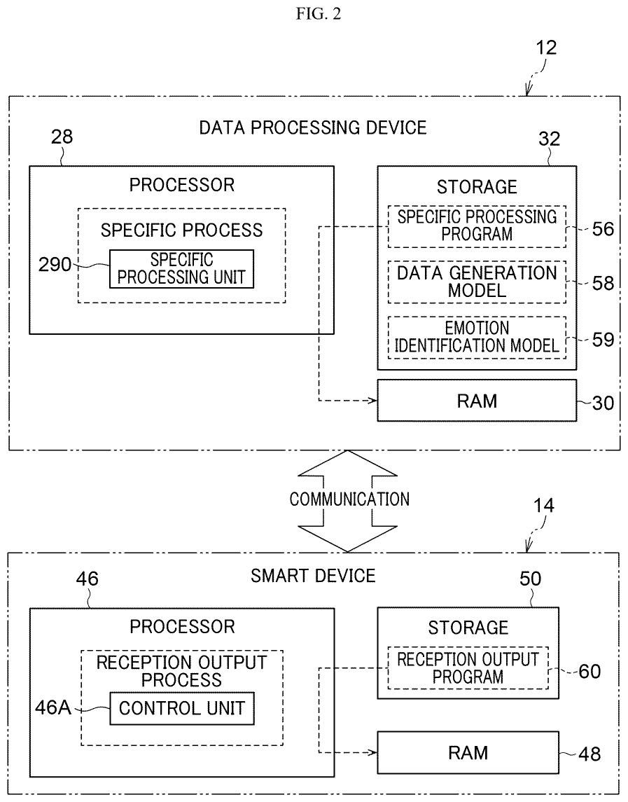

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for processing resume documents and interview records have several technical limitations that reduce overall efficiency and reliability of computer-based human resource management.

First, when image data of resumes and work history documents is processed, optical character recognition is typically executed as a standalone step, and the resulting raw text is stored without sufficient automatic structuring. This causes downstream components, such as search, filtering, and automated analysis modules, to repeatedly perform ad hoc parsing operations. As a result, processing pipelines are complex, error-prone, and computationally inefficient. In particular, conventional systems do not tightly integrate image preprocessing, optical character recognition, and structured data generation in a unified, processor-implemented workflow that is optimized for subsequent automated analysis.

Second, existing systems generally require a human operator to craft prompts or instructions for a generative artificial intelligence model based on the extracted information. This manual prompt creation is inconsistent, non-reproducible, and does not scale when processing large volumes of candidate data. Moreover, many known systems treat the generative artificial intelligence model as an external, generic utility, without programmatically binding the prompt generation process to the internal structured representation of candidate data. As a consequence, the quality and relevance of AI-generated summaries and evaluations vary greatly, and the system cannot reliably produce standardized outputs suitable for automated decision support.

Third, interview audio data is often stored separately from resume information, and its conversion into usable text and structured interview reports is typically performed manually or semi-manually. Known systems do not provide an integrated mechanism that automatically converts interview audio into text, transforms the text into structured interview record data, and then programmatically generates task-specific prompts for a generative artificial intelligence model to produce standardized interview reports. This fragmentation leads to duplicated processing, non-uniform report formats, and difficulty in associating interview content with existing candidate management records.

These limitations result in wasted computing resources, increased latency from document ingestion to usable analysis, and reduced accuracy and consistency of automated candidate evaluation. From a computer technology standpoint, there is a need for an improved system architecture and processing pipeline in which a processor coordinates: (i) acquisition and preprocessing of document images, (ii) extraction and structuring of textual information, (iii) automatic generation of prompt sentences tailored to specific summarization and evaluation tasks, and (iv) integrated handling of both resume documents and interview audio, so that the overall information processing system operates more efficiently, consistently, and reliably.

The specific processing by the specific processing unit 290 of the data processing device 12 in Example 1 is realized by the following means.

The present invention provides a server comprising a processor configured to acquire image data of documents including biography information and work history information via an image input device, perform image preprocessing and character recognition using image processing software and an optical character recognition engine to extract character information as digital text data, execute text formatting and item identification on the digital text data to generate structured data divided into attributes including personal identification information, contact information, work history information, educational history information, and skill information, store the structured data in an information management region of a data storage device, execute prompt generation logic to automatically generate, based on the structured data, prompt sentences that specify a summarization target, skills to be emphasized, an output format, and a length condition, provide to a generative artificial intelligence model input information including the prompt sentences and the relevant structured data so that the generative artificial intelligence model generates summary text or evaluation text regarding a candidate, store the generated summary text or evaluation text in association with the structured data and provide the generated text to a terminal device via a display interface, convert audio data acquired during or after an interview into text data by using an audio input device and a speech recognition engine, automatically generate interview content record data based on the converted text data, and generate additional prompt sentences including evaluation viewpoint information and output section information for the interview content record data so that the generative artificial intelligence model automatically generates structured interview report data including skill evaluation information, positive impression information, concern information, and recommended action information in association with candidate management information. This enables an integrated and technically improved information processing pipeline in which the server automatically transforms heterogeneous input data (including document images and interview audio) into structured data, dynamically generates task-specific prompt sentences tightly bound to that structured data, and invokes the generative artificial intelligence model in a consistent, machine-driven manner, thereby reducing manual intervention, improving processing throughput and latency, enhancing consistency and accuracy of summaries and evaluations, and providing a more efficient computer-implemented system for candidate information management.

The term “processor” refers to a hardware computation unit, such as a central processing unit or a processing core, that executes instructions to perform the operations described in the claims, including data acquisition, data transformation, prompt generation, and communication with external components.

The term “image input device” refers to an electronic apparatus, such as a scanner, a digital camera, or a multifunction imaging device, that captures visual information from a physical medium or a scene and outputs corresponding image data in a digital format.

The term “image data” refers to digital information representing a two-dimensional visual pattern, including pixel values or encoded image content, that is suitable for storage, transmission, and processing by the processor.

The term “image processing software” refers to a software component or module that performs operations on image data, such as resizing, noise reduction, contrast adjustment, deskewing, binarization, or other transformations that improve the quality of subsequent character recognition.

The term “optical character recognition engine” refers to a software and algorithmic component that analyzes image data containing printed or handwritten characters and outputs corresponding digital text data representing the recognized characters.

The term “character information” refers to symbolic content, such as alphabetic characters, numerals, and punctuation, that is contained in a document image and can be recognized and represented as digital text data.

The term “digital text data” refers to machine-readable text represented as a sequence of characters or code points that can be stored, searched, analyzed, and transformed by the processor.

The term “text formatting processing” refers to a set of operations applied to digital text data, including removal of unnecessary blanks and line breaks, normalization of spacing, and other structural adjustments that facilitate further parsing and analysis.

The term “item identification processing” refers to a procedure in which the processor analyzes digital text data to detect and classify segments of the text into predefined categories or attributes, such as names, addresses, and work history entries.

The term “structured data” refers to information that has been organized into a predefined schema or format, such as fields or records, enabling systematic storage, retrieval, and processing by software components or database systems.

The term “personal identification information” refers to attribute data that uniquely or specifically identifies an individual, such as a name, an identification number, or other identifiers associated with the candidate.

The term “contact information” refers to attribute data that enables communication with an individual, such as an address, an electronic mail address, a telephone number, or similar communication details.

The term “work history information” refers to attribute data describing a sequence of occupational experiences of a candidate, including organization identifiers, job titles, employment periods, and descriptions of job responsibilities.

The term “educational history information” refers to attribute data describing formal education experiences of a candidate, including institution identifiers, degrees, certifications, attendance periods, and graduation information.

The term “skill information” refers to attribute data describing capabilities, competencies, technical skills, or domain-specific proficiencies possessed by a candidate.

The term “information management region” refers to a logical or physical storage area within a data storage device in which structured data, summary text, evaluation text, and related management information are stored and managed under control of the processor.

The term “data storage device” refers to a hardware component or system, such as a magnetic disk, a solid-state drive, or a networked storage system, that stores digital information for subsequent retrieval and processing by the processor.

The term “prompt generation logic” refers to a software module or set of instructions executed by the processor to construct prompt sentences based on structured data and other context, including specification of summarization targets, emphasis points, output formats, and length constraints.

The term “prompt sentence” refers to a natural-language or structured instruction string that is provided as input to a generative artificial intelligence model to specify a requested processing task, such as summarization, evaluation, or report generation.

The term “generative artificial intelligence model” refers to a machine-learning model, such as a neural network-based language model, that receives input data including a prompt sentence and outputs generated content such as text summaries, evaluations, or reports.

The term “summary text” refers to generated text that provides a condensed representation of underlying data, such as a candidate's work history or interview content, while preserving key information elements.

The term “evaluation text” refers to generated text that provides an assessment or analysis of underlying data, such as an appraisal of a candidate's skills, strengths, weaknesses, or suitability for a role.

The term “terminal device” refers to an end-user computing apparatus, such as a personal computer, a tablet, or a mobile communication device, that communicates with the server, presents information to a user, and receives user inputs.

The term “display interface” refers to a software and hardware mechanism that enables the server to provide visual output to a terminal device, such as a graphical user interface, a web interface, or an application programming interface for presentation of information.

The term “audio data” refers to digital information representing sound signals, including recorded speech from an interview, that is suitable for storage, transmission, and processing by the processor.

The term “audio input device” refers to an electronic apparatus, such as a microphone or an audio capture module, that receives acoustic signals and converts them into corresponding audio data in a digital format.

The term “speech recognition engine” refers to a software and algorithmic component that processes audio data containing speech and outputs corresponding text data representing recognized spoken words.

The term “interview content record data” refers to structured or semi-structured data generated from text derived from interview audio, representing dialogue content, questions, answers, and other interview-related information.

The term “evaluation viewpoint information” refers to data describing predefined criteria, perspectives, or aspects to be considered when evaluating a candidate or interview content, such as technical ability, communication skill, or cultural fit.

The term “output section information” refers to data specifying sections, headings, or structural segments of a desired output document, such as separate portions for skills, positive impressions, concerns, and recommendations.

The term “interview report data” refers to structured or semi-structured generated text that summarizes and evaluates interview content according to specified sections and evaluation viewpoints.

The term “skill evaluation information” refers to generated content describing an assessment of a candidate's capabilities or competencies, based on resume data, interview data, or both.

The term “positive impression information” refers to generated content describing favorable observations or strengths identified during analysis of candidate data or interview content.

The term “concern information” refers to generated content describing potential risks, weaknesses, or issues identified during analysis of candidate data or interview content.

The term “recommended action information” refers to generated content describing suggested next steps or decisions regarding a candidate, such as advancing to another selection stage or requesting additional information.

The term “candidate management information” refers to stored data related to the administration and tracking of candidates within a system, including identifiers, status indicators, associated documents, interview records, and evaluation results.

In one embodiment, a server cooperates with one or more terminals operated by a user to implement the claimed system. The server includes a processor, a main memory, and one or more data storage devices such as magnetic disks or solid-state drives. The server is connected to the terminals via a communication network such as the Internet, and the terminals are implemented, for example, as personal computers, tablet devices, or mobile communication terminals equipped with an image input device and an audio input device.

The terminal acquires document image data by controlling an image input device such as a flatbed scanner or a digital camera. The terminal executes scanning software, for example a generic scanning application using a TWAIN or WIA driver, to control the image input device. The terminal sends scan commands to the image input device, receives raw bitmap data, and encodes the bitmap data into an image file using an image encoding library. The terminal then transmits the encoded image data to the server by using an HTTP or HTTPS communication protocol.

The server receives the transmitted image data and stores the image data in a storage region of the data storage device. The server uses image processing software, for example an image processing library such as a general-purpose image processing toolkit that provides grayscale conversion, binarization, deskewing, denoising, and contrast adjustment functions. The server applies these image processing operations to the received image data to enhance character edges and to reduce image noise. This preprocessing increases the recognition rate of a subsequent optical character recognition engine and reduces the need for re-processing images.

The server uses an optical character recognition engine, for example a general-purpose optical character recognition engine such as an open-source engine or a commercial engine, to convert the preprocessed image data into digital text data. The optical character recognition engine analyzes connected components in the binarized image, segments characters and lines, classifies glyphs by using pattern recognition or a neural network classifier, and outputs a sequence of characters. In one embodiment, the optical character recognition engine internally uses a convolutional neural network to extract features from small image patches and a sequence model such as a recurrent neural network or a transformer-type attention mechanism to decode character sequences. The server specifies language parameters and page segmentation modes to the optical character recognition engine to optimize segmentation for resume-like layouts.

The server performs text formatting processing on the output of the optical character recognition engine. The server uses string manipulation and pattern matching to delete unnecessary spaces and line breaks, normalize character encoding, and remove non-informative headers and footers. The server then performs item identification processing to detect semantic segments such as personal identification information, contact information, work history information, educational history information, and skill information. The server uses rule-based parsing together with statistical natural language processing. The rule-based parsing includes regular expressions that detect labels such as “Name”, “Address”, “Email”, “Phone”, “Work Experience”, or date patterns. The statistical processing uses a sequence labeling model trained on labeled resume data, for example a conditional random field or a transformer-based encoder that outputs token-level tags such as PERSON_NAME, COMPANY, ROLE, PERIOD, or SKILL. The server combines outputs of the rule-based and statistical modules to improve robustness against layout variations.

The server converts the result of the item identification processing into structured data. In one embodiment, the server stores the structured data as records in relational database tables with fields for candidate identifier, attribute type, and attribute value. In another embodiment, the server stores the structured data as hierarchical records in a document-oriented database using a schema with nested objects for work history entries and education entries. The server thereby creates a uniform data schema from heterogeneous resume documents. This uniform data schema enables the server to avoid repeated ad hoc parsing in later stages and reduces computational overhead in search and summary generation.

The server executes prompt generation logic to construct a prompt sentence to be provided to a generative AI model. The server reads structured fields such as total years of work experience, main skills, last job title, and domain of the position from the database. The server then inserts these field values into template patterns maintained in memory. For example, the server generates prompt sentences such as:

“Summarize this candidate's work experience focusing on Java, React, and SQL and the overall impact on past projects. The candidate has 5 years of experience and most recently worked as a software engineer. Use concise professional language suitable for a hiring manager.”

or

“Based on the following structured candidate data, create a concise profile highlighting main skills, key achievements, and suitability for a backend engineer role.”

The server can also generate task-specific prompts for different outputs. For instance, the server generates a prompt sentence:

“Extract the three most important strengths and two main concerns regarding this candidate, using the following work history and skills. Present the result as numbered lists under the headings ‘Strengths’ and ‘Concerns’.”

The server then concatenates the structured data as a textual appendix to the prompt sentence. The prompt generation logic is not a generic text concatenation, but uses decision rules. For example, if the years of experience exceed a threshold, the server adds language for senior-level evaluation; if the main skills include certain technologies, the server requests the generative AI model to focus on those technologies. This conditional prompt generation is implemented as a set of programmatic rules and parameterized templates, which ensures consistency and reduces variance compared with manual prompt design.

The server provides the generated prompt sentence and the associated data to a generative AI model. In one embodiment, the generative AI model is a transformer-based neural network language model deployed on a separate computation node. The model includes an embedding layer to convert tokens into vectors, multiple self-attention layers with multi-head attention, layer normalization, and position-wise feedforward networks, and a final linear layer with a softmax output for next-token prediction. The server sends a tokenized representation of the prompt sentence and appended structured data to the model. During inference, the model uses attention mechanisms to compute context vectors and iteratively generates output tokens representing the summary or evaluation text. The server configures generation parameters such as maximum token length, sampling temperature, and top-k or top-p sampling thresholds to control output length and diversity.

The server receives the output tokens from the generative AI model and decodes the tokens into human-readable text, thereby obtaining summary text or evaluation text. The server stores this text in the data storage device associated with the corresponding candidate identifier and the underlying structured data. The server uses indexing structures, such as an inverted index or a columnar index, to store the generated text and to enable efficient retrieval and search.

The server provides the structured data and generated text to the terminal via a display interface. The terminal renders the data in a graphical user interface running in a web browser or native application. The terminal may display, for example, a candidate's name, key skills, and an AI-generated summary in a single view.

The user operates the terminal to review the summaries and evaluations. The user may provide feedback flags such as “useful” or “not useful,” or may annotate particular output segments. The server can optionally log such feedback to update tuning parameters for the prompt generation logic or to retrain the generative AI model on domain-specific data in a separate training phase.

The terminal also acquires interview audio data using an audio input device such as a microphone. The terminal encodes the captured sound signal into digital audio data, for example in a waveform format or a compressed audio format, and transmits the audio data to the server using a network protocol. The server stores the audio data in the data storage device and invokes a speech recognition engine. In one embodiment, the speech recognition engine is implemented as a neural network that includes a feature extractor, such as a convolutional layer operating on log-mel spectrograms, and a sequence decoder such as a recurrent neural network, a transformer encoder-decoder, or a connectionist temporal classification architecture. The engine outputs a sequence of words or subword units representing the recognized speech.

The server converts the output of the speech recognition engine into continuous text, optionally including time stamps or speaker labels. The server performs text cleanup operations similar to those performed for resume text, such as removal of filler words and normalization of punctuation. The server then generates interview content record data by segmenting the transcript into question-answer pairs or topic sections. The server uses rule-based patterns such as interrogative forms or explicit question markers to detect interviewer questions and segments candidate responses accordingly. The server stores the interview content record data in the database associated with the candidate identifier and with the corresponding interview session.

The server executes prompt generation logic specifically for interview summarization and evaluation. The server composes prompt sentences that instruct the generative AI model to generate structured reports. Example prompt sentences include:

“Based on the following interview transcript with a candidate for a software engineer position, create a concise interview report with the sections: ‘Main skills and experiences’, ‘Positive impressions’, ‘Concerns or risks’, and ‘Recommended next steps’. Use bullet points under each section.”

and

“From the following interview content, summarize the candidate's technical strengths, communication style, and any red flags. Limit the answer to approximately 300 words.”

The server attaches the interview content record data to the prompt sentence and sends this input to the generative AI model. The generative AI model processes the transcript-conditioned prompt and outputs interview report data structured according to the requested sections. The server parses the generated output by detecting section headings and bullet indicators, and stores each section in separate fields in the database. This structured storage of interview report data allows the server to quickly retrieve and compare candidates along specific dimensions such as “concerns or risks” or “recommended next steps.”

The server thereby achieves technical effects beyond mere automation of human reading and summarization. The server reduces total processing time from ingestion of document images and interview audio to generation of usable structured outputs by: (i) combining image preprocessing and OCR in a pipeline optimized for resume layouts, (ii) normalizing and structuring textual information so that later modules operate on uniform schemas instead of raw strings, and (iii) programmatically generating task-specific prompt sentences that harness the generative AI model in a deterministic and repeatable manner. These design choices reduce the number of parsing passes over the data and prevent repeated execution of expensive pattern recognition operations.

The server also improves accuracy, because the preprocessing and item identification steps reduce OCR noise and misclassification before the generative AI model consumes the data. Structured attribute boundaries, such as separation of work history entries and skill lists, guide the generative AI model to attend to relevant tokens and avoid mixing unrelated segments. This leads to more stable and accurate summaries and evaluations compared with feeding raw unstructured text.

The server improves data management by storing both the structured data and the generated outputs in indexed storage structures and by associating them with candidate management information. This allows the server to respond to complex queries, such as retrieving all candidates whose AI-generated reports mention a specific risk keyword, without rescanning source documents.

The server improves computational efficiency by separating the heavy optical character recognition and speech recognition computations from the generative text computations and by only invoking the generative AI model when sufficient structured context has been formed. Because the generative AI input length is controlled through prompt templates and attribute selection, communication load between the server and the generative AI computation node is reduced, which lowers bandwidth usage and latency.

From the perspective of AI and machine learning processing, the system does not merely state that AI performs a task. The server explicitly uses models with defined architectures, such as transformer-based networks for language generation and attention-based or recurrent networks for speech recognition and optical character recognition. The server uses defined training methods in an offline phase, for example stochastic gradient descent with backpropagation, mini-batch optimization, and loss functions such as cross-entropy to minimize prediction error over training corpora of resumes and interview transcripts. Data augmentation techniques such as adding synthetic noise to images or inserting pauses in audio improve robustness of recognition models. Hyperparameters such as learning rate, number of layers, number of attention heads, and vocabulary size are determined through validation experiments. Although these training operations may be performed on separate hardware before deployment, the deployed models in the server embody the resulting parameter sets, and the server uses those parameter sets in a concrete way to process incoming data.

The system also employs non-conventional processing sequences. For example, the prompt generation logic uses rule-based conditions derived from structured attributes to control how the generative AI model is queried, rather than allowing arbitrary free-form prompts. The server may, for example, change the length constraint in the prompt sentence based on the number of work history entries, or instruct the model to omit redundant education details when multiple similar entries are detected. Such rule-based control over prompt content constitutes a deterministic algorithm that coordinates interaction between structured data modules and neural network modules, and this coordination leads to repeatable and verifiable behavior of the overall system.

Alternative embodiments are possible. The terminal may directly run the image processing and optical character recognition software and send structured data to the server, in which case the server still performs prompt generation and generative AI interaction. In another embodiment, the generative AI model is executed on the same physical server as the optical character recognition engine, reducing network latency between modules. In yet another embodiment, the server uses different databases for resume data and interview data, or uses in-memory key-value stores for frequently accessed attributes to further reduce response time.

In all such embodiments, the server, the terminal, and the user collaborate through defined hardware and software interfaces so that documents in physical or unstructured digital form are transformed into structured, machine-usable representations and further transformed into concise, standardized texts by a generative AI model under programmatic control. This architecture improves computer performance in terms of processing speed, accuracy, and resource usage, and provides a concrete technical implementation that surpasses ordinary manual data processing or generic computerization of human tasks.

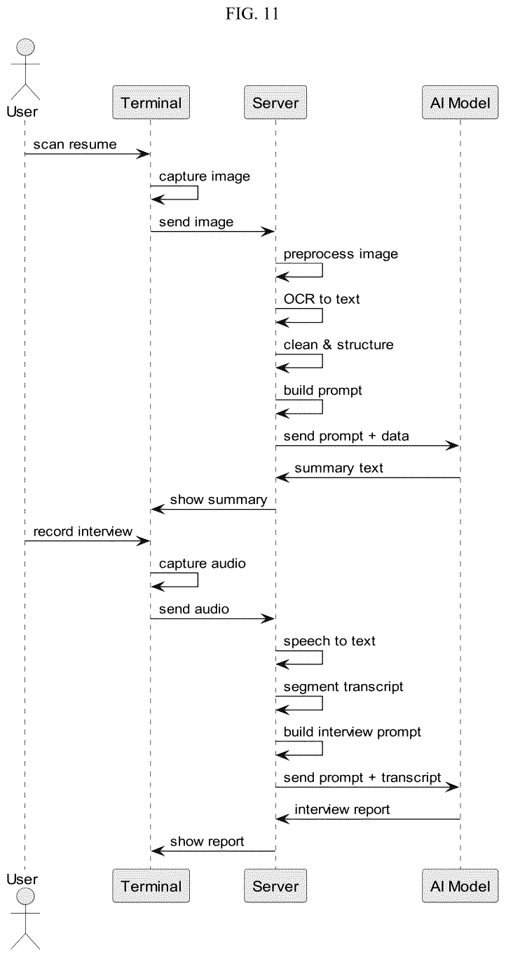

The following describes the processing flow using FIG. 11.

### Step 1

The user prepares a physical document containing resume information or work history information.

The terminal receives a user instruction to scan or capture the document image.

Input: a physical paper document.

Output: digital image data representing the document.

The terminal controls an image input device, such as a scanner or digital camera, by issuing a scan or capture command through a device driver interface. The terminal receives raw raster data from the image input device, converts the raster data into an encoded image format such as PNG or JPEG, and stores the encoded image file in local storage. The terminal then associates basic metadata, such as a candidate identifier and a timestamp, with the stored image file.

### Step 2

The terminal transmits the acquired document image data to the server.

Input: encoded image file and associated metadata stored on the terminal.

Output: image data and metadata delivered to the server via a communication channel.

The terminal reads the encoded image file from its storage and constructs a network request, for example an HTTPS POST request, to a predefined server endpoint. The terminal attaches the image file as a binary payload and includes metadata fields such as candidate identifier, document type, and file name in the request headers or body. The terminal then sends the request through a network stack, waits for a confirmation response from the server, and records the server-side document identifier returned in the response.

### Step 3

The server receives and stores the uploaded document image data.

Input: network request containing the image data and metadata from the terminal.

Output: stored image data in a data storage device and a corresponding document record.

The server parses the incoming HTTP request, extracts the binary image payload and metadata, and writes the image data into a storage region of a data storage device under a generated file path. The server creates or updates a document record in a database, registering fields such as candidate identifier, file path, document type, and processing status. The server sets the processing status to an initial state indicating that optical character recognition has not yet been performed.

### Step 4

The server performs image preprocessing for optical character recognition.

Input: document image data retrieved from the data storage device.

Output: preprocessed image data optimized for character recognition.

The server loads the stored image file into memory and invokes image processing software. The server converts the image to grayscale, applies contrast enhancement, performs noise reduction using filters, and executes deskewing algorithms to correct rotation. The server may then apply binarization to separate foreground text from background. These operations convert the input pixel matrix into a new pixel matrix with improved text visibility. The server writes the preprocessed image into a temporary memory buffer or a temporary file for subsequent recognition.

### Step 5

The server executes optical character recognition on the preprocessed image.

Input: preprocessed image data stored in memory or as a temporary file.

Output: raw digital text data representing recognized characters.

The server calls an optical character recognition engine and supplies the preprocessed image as input, along with configuration parameters such as language codes and page segmentation mode. The optical character recognition engine analyzes connected components, segments characters and text lines, and uses pattern classifiers or neural network layers to map image features to character codes. The server receives the recognition result as a text string or structured text blocks and stores this raw digital text data in memory or in a temporary text storage region.

### Step 6

The server performs text formatting processing on the raw digital text data.

Input: raw digital text data produced by the optical character recognition engine.

Output: cleaned and normalized text data.

The server executes string processing routines that scan the raw text character by character. The server removes redundant spaces, merges unnecessary line breaks, and normalizes character encoding. The server may remove page numbers or scanning artifacts by detecting known patterns. This processing transforms an irregular, noisy text stream into a more regular text sequence. The server outputs the cleaned text data as a normalized text block stored in memory.

### Step 7

The server performs item identification processing to generate structured data.

Input: cleaned and normalized text data representing the contents of the resume document.

Output: structured data divided into predefined attribute fields.

The server analyzes the normalized text using rule-based patterns and statistical models. The server applies regular expressions to locate labels such as names, addresses, and headings like “Work Experience” or “Education.” The server also applies a sequence labeling model, such as a trained tagger, to assign semantic tags to tokens, distinguishing person names, company names, job titles, dates, and skills. The server then groups tokens according to assigned tags and positional cues, forming attribute values such as personal identification information, contact information, work history entries, educational history entries, and skill lists. The server represents this result as structured data, for example as database fields or hierarchical objects, and writes the structured data into an information management region of the data storage device.

### Step 8

The server associates the structured data with candidate management information.

Input: structured data derived from the document and an existing or newly created candidate record.

Output: updated candidate management record linked to the structured data.

The server searches a candidate table using the candidate identifier obtained from metadata or from parsed content. If the candidate record exists, the server attaches the new structured data to the existing record; otherwise, the server creates a new candidate record with a unique identifier and stores the structured data therein. The server updates index structures to allow efficient retrieval by name, skill, or other attributes. This association step transforms previously isolated document data into part of an integrated candidate information model.

### Step 9

The server generates a prompt sentence for resume summarization based on the structured data.

Input: structured data including fields such as work history information, skill information, experience duration, and job category.

Output: a task-specific prompt sentence for a generative AI model.

The server reads selected fields from the structured data, such as total years of experience, key technologies, and the most recent job title. The server applies prompt generation logic that uses conditional rules and template strings. If the experience duration exceeds a threshold, the server selects a template that requests a senior-level summary; if specific skills such as particular programming languages appear, the server inserts those skill names into emphasis phrases. For example, the server may generate prompt sentences such as:

“Summarize this candidate's work experience focusing on Java, React, and SQL and the overall impact on past projects. The candidate has 5 years of experience and most recently worked as a software engineer. Use concise professional language suitable for a hiring manager.”

The server outputs the generated prompt sentence as a text string ready to be combined with supporting data.

### Step 10

The server prepares input data for the generative AI model.

Input: generated prompt sentence and structured data related to the candidate.

Output: a combined input sequence for the generative AI model.

The server concatenates the prompt sentence with a textual representation of the structured data, separating segments with delimiters and labels. The server then tokenizes the combined text into tokens accepted by the generative AI model. The server forms a sequence of token identifiers and packs them into a data structure such as a tensor or an array. The server also sets generation parameters, such as maximum length and sampling strategy, and prepares a model invocation request that includes the token sequence and parameters.

### Step 11

The server invokes the generative AI model to generate summary or evaluation text.

Input: tokenized prompt sentence and structured data sequence, along with model generation parameters.

Output: generated token sequence representing summary text or evaluation text.

The server sends the prepared input data to the generative AI model, which may run on the same server or on a separate computing node. The generative AI model processes the tokens through its neural network layers and predicts successive output tokens according to the configured constraints. The server receives the generated token IDs from the model, decodes the token IDs back into characters, and forms a coherent text. This text provides a summary or evaluation of the candidate's history according to the instructions contained in the prompt sentence.

### Step 12

The server stores and serves the generated summary or evaluation text.

Input: generated summary or evaluation text and corresponding candidate identifier.

Output: stored summary or evaluation text accessible for display.

The server writes the generated text into a storage field associated with the candidate record in the database. The server updates indexes for quick search or filtering based on content keywords. When a terminal requests candidate information, the server retrieves the stored summary or evaluation text and packages it with relevant structured data in a response message. The server then sends the response back to the terminal for user display.

### Step 13

The terminal displays the structured data and generated text to the user.

Input: response message containing structured candidate data and summary or evaluation text from the server.

Output: visual presentation of candidate information on a screen.

The terminal parses the received data and renders user interface elements that show selected fields, such as name, skills, and career history, together with the AI-generated summary or evaluation. The terminal arranges these elements on the screen and updates any interactive components to allow the user to scroll, filter, or annotate the displayed information.

### Step 14

The user initiates recording of interview audio on the terminal.

Input: user action indicating start and end of an interview recording session.

Output: audio data file stored on the terminal.

The terminal controls an audio input device, such as a microphone, by invoking operating system audio APIs to start capturing sound. The terminal encodes the captured audio samples into a digital audio format, buffers the samples in memory, and writes them to a file on local storage when the user ends the recording. The terminal associates metadata such as candidate identifier, interviewer identifier, and time information with the audio file.

### Step 15

The terminal uploads the interview audio data to the server.

Input: recorded audio file and metadata stored on the terminal.

Output: audio data delivered to the server for processing.

The terminal constructs a network request and attaches the audio file in the request body, including metadata fields such as candidate identifier and interview session identifier. The terminal sends the request to a designated server endpoint and waits for confirmation. Upon success, the terminal records the server-assigned audio record identifier for later reference.

### Step 16

The server converts the interview audio data into text data using a speech recognition engine.

Input: stored interview audio data from the data storage device.

Output: raw transcript text representing recognized speech.

The server loads the audio file and feeds the audio signal into a speech recognition engine. The speech recognition engine extracts acoustic features, aligns them over time, and uses a sequence model to map the features to text. The server receives the output as a sequence of words or subword units and concatenates them to form a transcript string. The server stores the transcript in association with the audio record and candidate identifier.

### Step 17

The server processes the transcript to generate interview content record data.

Input: raw transcript text produced by the speech recognition engine.

Output: structured interview content record data.

The server cleans the transcript by removing disfluencies and normalizing punctuation. The server applies pattern recognition to detect interviewer questions and candidate responses, such as by identifying interrogative phrases or known question markers. The server segments the transcript into labeled parts, for example questions, answers, and topic changes, and stores these segments as structured interview content record data in the database.

### Step 18

The server generates a prompt sentence for interview summarization and evaluation.

Input: structured interview content record data and contextual candidate information.

Output: a prompt sentence tailored for interview report generation.

The server reads key elements from the interview content, such as technical topics discussed, strengths mentioned, and concerns raised. The server applies prompt generation logic that selects an appropriate template and fills in parameters such as role type and desired section headings. For example, the server may generate a prompt sentence such as:

“Based on the following interview transcript with a candidate for a software engineer position, create a concise interview report with the sections: ‘Main skills and experiences’, ‘Positive impressions’, ‘Concerns or risks’, and ‘Recommended next steps’. Use bullet points under each section.”

The server outputs this prompt sentence in preparation for generative AI processing.

### Step 19

The server invokes the generative AI model to create structured interview report data.

Input: prompt sentence for interview summarization and evaluation, and interview content record data.

Output: generated interview report text structured into predefined sections.

The server concatenates the prompt sentence and the interview content record data, tokenizes the combined text, and sends the token sequence to the generative AI model. The generative AI model produces an output sequence describing interview results according to the requested sections. The server decodes the output sequence to obtain the interview report text. The server parses the interview report text to separate each section, such as “Main skills and experiences” or “Concerns or risks,” and stores these sections as structured interview report data linked to the candidate record.

### Step 20

The terminal retrieves and presents the interview report to the user.

Input: structured interview report data and candidate identifier retrieved from the server.

Output: visual display of structured interview report information.

The terminal receives a response from the server containing sectioned interview report data and displays each section with appropriate headings. The terminal may present bullet points for skills, positive impressions, concerns, and recommended actions. The user can review the report on the screen, compare multiple candidates, and optionally provide additional annotations.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recruitment support systems that merely digitize resumes and interview notes suffer from several technical limitations in how they process, represent, and deliver information within computer systems. First, when image data including personal history information and work history information is acquired by a scanner or digital camera, optical character recognition is often executed directly on the raw image data. This leads to sub-optimal character recognition accuracy due to noise, skew, and inconsistent lighting conditions, which in turn produces low-quality text data. As a result, downstream natural language processing pipelines running on the computer cannot reliably extract ability information or experience information, and structured information stored in memory and storage subsystems is degraded in accuracy and consistency.

Second, conventional systems tend to store only unstructured or semi-structured text in a data storage device, without generating well-defined structured information that is optimized for computational evaluation. This forces later evaluation processes to repeatedly parse and reinterpret raw text, increasing processor load, memory access overhead, and latency. The absence of a unified structured representation of applicant information and organization requirement information also prevents efficient and reproducible suitability calculation by the processor.

Third, when generative models are used, existing approaches typically submit free-form text to a generative model without generating prompt sentences that are systematically derived from structured information inside the system. This results in non-deterministic outputs, difficulty in controlling the output format, and inability to reliably associate generated content, such as evaluation explanation information and question candidate information, with internal records maintained in the data storage device. Consequently, the interaction between deterministic program logic and generative models is loosely coupled and technically inefficient.

Fourth, existing systems that generate interview records often rely on manual transcription or simple speech-to-text conversion, without integrating the transcription step with structured prompt generation for a generative model. This prevents the system from consistently producing structured interview record information that is aligned with previously computed suitability information and stored structured information, thereby limiting the system's ability to maintain coherent, machine-processable records across the entire hiring workflow.

Accordingly, there is a need for a computer-implemented system that technically improves (i) the accuracy and reliability of text information extraction from image information and audio information through coordinated preprocessing, recognition, and natural language processing, (ii) the internal data architecture by generating and storing structured information suitable for automated comparison and reasoning, and (iii) the interaction between deterministic processing components and a generative model by generating prompt sentences based on structured internal representations so that the outputs of the generative model can be deterministically tied back to stored data and efficiently delivered to a user terminal. The technical problem addressed by the invention is to improve the functioning of a computer system that processes applicant-related information, by enhancing data quality, data structure, and the integration with generative processing, thereby reducing computational redundancy, improving processing throughput, and increasing the reliability and consistency of information presented to users.

The specific processing by the specific processing unit 290 of the data processing device 12 in Application Example 1 is realized by the following means.

The present invention provides a server comprising a processor configured to collect image information representing personal history information and work history information by using an image capturing device, execute image processing on the image information to generate processed image information having improved accuracy for character recognition processing, apply optical character recognition processing to the processed image information to extract character information as text information, apply natural language processing to the text information to generate structured information including ability information and experience information of an applicant, calculate suitability information of the applicant based on the structured information and requirement information on an organization side, generate a prompt sentence for causing a generative information processing model to generate evaluation explanation information and question candidate information using evaluation target information including the structured information and the requirement information as input, input the prompt sentence into the generative information processing model to obtain the evaluation explanation information and the question candidate information, convert audio information acquired during an interview into text information by speech recognition processing, generate a prompt sentence for causing the generative information processing model to generate interview record information using the text information as input, input the prompt sentence into the generative information processing model to obtain the interview record information, and provide the suitability information, the evaluation explanation information, the question candidate information, and the interview record information as output information to a user terminal. This enables improvement of the overall computer system performance and reliability by (i) enhancing recognition accuracy through dedicated image processing prior to optical character recognition, (ii) maintaining internally consistent structured information optimized for automated suitability calculation in memory and storage subsystems, and (iii) tightly integrating deterministic processing with generative processing via structured prompt sentences, so that generated explanations, questions, and interview records are systematically derived from and linked back to internal data, thereby reducing redundant computation, lowering latency, and producing more consistent and machine-processable outputs for use in recruitment workflows.

The term “image information” refers to digital data representing a visual depiction of content, including but not limited to a resume, curriculum vitae, or work history document, acquired by an image capturing device as a still image or a sequence of images.

The term “personal history information” refers to information describing an individual's background, including but not limited to education, training, qualifications, and other biographical data relevant to employment.

The term “work history information” refers to information describing an individual's past or current occupational activities, including but not limited to job titles, responsibilities, employment periods, and industry sectors.

The term “image capturing device” refers to any hardware or combination of hardware configured to acquire image information, including but not limited to a scanner, a digital camera, an integrated camera in a portable terminal, or any other opto-electronic imaging apparatus.

The term “image processing” refers to computational operations applied to image information, including but not limited to grayscale conversion, binarization, noise reduction, skew correction, contrast adjustment, and region detection, for the purpose of improving subsequent character recognition.

The term “processed image information” refers to image information that has been modified by image processing so as to improve the quality or usability of the image for further computational processing, such as optical character recognition.

The term “character recognition processing” refers to computational operations for detecting and identifying characters or symbols contained in image information and generating corresponding digital representations of such characters or symbols.

The term “optical character recognition processing” refers to character recognition processing that analyzes rasterized or pixel-based image information of text regions to produce machine-readable character codes as text information.

The term “text information” refers to digital data representing a sequence of characters, words, or sentences in a natural or formal language, obtained, for example, as output from optical character recognition processing or speech recognition processing.

The term “natural language processing” refers to computational techniques and algorithms for analyzing, interpreting, and transforming text information expressed in a natural language, including but not limited to tokenization, part-of-speech tagging, syntactic parsing, entity recognition, and information extraction.

The term “structured information” refers to information arranged according to a predefined data model or schema, such as key-value pairs, records, or hierarchically organized fields, enabling deterministic access, comparison, and processing by a computer.

The term “ability information” refers to structured information describing an applicant's skills, competencies, qualifications, or proficiencies, including but not limited to technical skills, domain knowledge, and soft skills.

The term “experience information” refers to structured information describing an applicant's practical background, including but not limited to durations of employment, types of roles held, projects executed, and responsibilities undertaken.

The term “requirement information” refers to structured information describing desired or mandatory criteria of an organization, including but not limited to required skills, minimum experience levels, preferred backgrounds, and other conditions for a position or role.

The term “suitability information” refers to information indicating a degree of match between applicant-related structured information and requirement information, including but not limited to scores, ratings, or categorical indicators representing how well an applicant fits specified criteria.

The term “evaluation target information” refers to information provided as input to an evaluation process, including at least structured information relating to an applicant and requirement information relating to an organization, and optionally additional contextual data.

The term “prompt sentence” refers to text information formulated in a natural or formal language that is configured as an input instruction to a generative information processing model, specifying a task, constraints, or desired output format.

The term “generative information processing model” refers to a computational model configured to generate text or other data in response to input information, including but not limited to a neural network-based language model or other machine learning model capable of producing new content conditioned on a prompt sentence.

The term “evaluation explanation information” refers to information generated by deterministic processing or by a generative information processing model that describes, in natural language or structured form, reasons or factors underlying a suitability assessment of an applicant.

The term “question candidate information” refers to information representing one or more proposed questions or inquiry topics, generated based on evaluation target information, for use during an interview or further assessment of an applicant.

The term “audio information” refers to digital data representing sound, including but not limited to waveforms or encoded audio signals, acquired during an interview or similar session.

The term “speech recognition processing” refers to computational operations that analyze audio information representing spoken language and convert the audio information into corresponding text information.

The term “interview record information” refers to information representing a structured or summarized record of an interview, including but not limited to outlines, key points, identified strengths and weaknesses, and recommendations, generated at least in part from text information derived from the interview.

The term “user terminal” refers to any computing device operated by a user to send or receive information to or from a server, including but not limited to a portable terminal, a desktop computer, a tablet device, or a web client.

The term “output information” refers to information that is transmitted from the server to the user terminal, including at least suitability information, evaluation explanation information, question candidate information, and interview record information, for presentation or further processing.

The term “information storage device” refers to any physical or logical data storage resource configured to store digital information, including but not limited to a magnetic storage device, a solid-state storage device, an optical storage device, or a network-based storage service.

The term “formatted information” refers to text information or structured information that has been arranged or transformed to conform to a predetermined information structure, schema, or format for storage or subsequent processing.

The term “display information for display control” refers to information that specifies content and layout for presenting data on a display unit of a user terminal, including but not limited to identifiers, text content, and structural metadata used by a user interface component.

In one embodiment, a server cooperates with one or more terminals operated by a user to implement the claimed system. The server comprises at least one processor, a memory, a non-transitory storage device, and a network interface. The terminal comprises a processor, a memory, a camera device, a microphone, a display unit, and a communication interface. The user operates the terminal to capture applicant information, initiate processing on the server, and review output information.

The server executes an operating system such as a general-purpose server operating system and runs application software implemented, for example, using a server-side framework. The server further executes an image processing library such as a general-purpose image processing library (e.g., a library implementing grayscale conversion, thresholding, noise reduction, and geometric correction), an optical character recognition engine such as a general-purpose OCR engine, a natural language processing library such as a general-purpose NLP framework (e.g., one providing tokenization, part-of-speech tagging, dependency parsing, and named entity recognition), a speech recognition engine such as an automatic speech recognition system (e.g., an encoder-decoder neural network with attention), and a generative AI model such as a large-scale transformer-based language model.

The terminal executes an operating system such as a mobile operating system and an application program implementing a client interface. The terminal uses its camera hardware via a camera control API to acquire image information representing resumes and work history documents. The terminal converts the captured optical signal into digital image information in formats such as JPEG or PNG, stores the image information in local memory, and transmits the image information to the server via a secure network protocol (for example, HTTPS). The terminal also uses its microphone via an audio capture API to acquire audio information during interviews, encodes the audio information in formats such as WAV or AAC, and transmits the audio information to the server.

The server receives the image information via the network interface and stores the received data in the storage device. The server executes image processing operations on the image information. The server converts color image data into grayscale data, applies adaptive thresholding to distinguish foreground text from background, performs noise reduction using a convolutional filter, and detects skew by analyzing horizontal projections or Hough transforms of detected lines. The server rotates the image data to correct orientation and optionally segments the image into regions likely to contain text by connected-component analysis or contour detection. By performing these operations, the server generates processed image information in which text regions are more sharply defined and background noise is reduced, which improves the accuracy of subsequent optical character recognition.

The server applies optical character recognition processing to the processed image information. The server passes the processed image information to the OCR engine, which internally converts the pixel data into normalized glyph representations, extracts features such as stroke directions, curvature, and local gradients, and compares the features to a trained character classification model. In one embodiment, the OCR engine uses a convolutional neural network trained with a cross-entropy loss function over labeled character images to map patches of the processed image information to character codes. The server receives character codes and layout information from the OCR engine and constructs text information, including line breaks and basic document structure inferred from OCR layout analysis. The server stores the resulting text information in the storage device associated with identifiers of the corresponding image information.

The server applies natural language processing to the text information. The server loads the text information into main memory and applies a tokenizer that segments the text into tokens based on whitespace, punctuation, and language-specific morphological rules. The server uses a part-of-speech tagger to label each token with grammatical categories, and a dependency parser to identify syntactic relations such as subject, object, and modifiers. The server uses named entity recognition to detect entities corresponding to job titles, organization names, technology names, time expressions, and qualification names. In one embodiment, the server employs a statistical sequence labeling model, such as a bidirectional recurrent neural network with conditional random field decoding, trained to identify entity boundaries and types. The server also applies rule-based patterns (e.g., regular expressions aligned with linguistic annotations) to identify phrases such as “X years of Y experience” and “team leader” and associates numeric values with corresponding skill categories.

The server converts extracted elements into structured information. The server creates a data structure such as a record or object including fields for skills, experience durations, industry sectors, job roles, and educational background. The server, for example, represents years of experience as normalized numerical values, maps free-text skill descriptions to canonical skill identifiers using a controlled vocabulary, and associates each identified job role with a start and end date if available. The server stores this structured information in the storage device, for example in a relational database table or a key-value store, using indexes that enable efficient retrieval by applicant identifier or skill category. By maintaining structured information rather than only raw text, the server reduces the need for repeated parsing and enables deterministic, lower-latency computation of suitability information.

The server also maintains requirement information representing organization-side criteria. The server stores requirement information in the storage device as structured records containing required skills, preferred skills, minimum and target years of experience, acceptable industries, and weighting factors. The server retrieves requirement information corresponding to a particular position based on a position identifier supplied by the terminal.

The server loads both the structured applicant information and the requirement information into memory and executes a suitability calculation algorithm.

The server calculates suitability information by comparing structured applicant information with requirement information. The server maps each required and preferred skill to binary or graded match values based on the applicant's structured information. The server checks numeric constraints such as whether the applicant's years of experience in a target category exceed or meet minimum thresholds. In one embodiment, the server computes a weighted sum of matched required skills and matched preferred skills, with higher weights assigned to required skills, and normalizes the sum to a numerical score in a predetermined range, such as 0 to 100. The server also determines a categorical label (“high”, “medium”, “low”) by applying threshold rules to the score. This algorithmic approach improves consistency and reduces processor cycles relative to re-parsing free-text data for each evaluation.

The server generates prompt sentences for a generative AI model based on the internal structured information. The server constructs a prompt sentence by formatting the structured applicant information and requirement information into human-readable text that maintains explicit field boundaries. In one example, the server produces a prompt sentence such as:

“You are an assistant that evaluates candidates for a retail position. Here is the candidate's structured resume data: skills: sales, leadership; years of sales experience: 5; industries: retail. Here are the store's requirements: required skills: sales; minimum years of sales experience: 3; preferred skill: leadership. Evaluate whether the candidate fits the store's needs. Provide a suitability score from 0 to 100 and a short explanation.”

The server passes the prompt sentence to the generative AI model. The generative AI model in one embodiment is implemented as a transformer-based neural network comprising an embedding layer, multiple self-attention layers, feed-forward layers, and a final output layer trained on large corpora of text. The model stores parameters as numerical weights in memory and performs multiple matrix multiplications and non-linear activation functions during inference. The model has been trained using a language modeling objective and optionally fine-tuned with instruction-following data, using loss functions such as negative log-likelihood and optimization methods such as stochastic gradient descent with adaptive moment estimation. The server provides the prompt sentence as a sequence of token identifiers to the model and receives a sequence of output tokens, which the server decodes into evaluation explanation information and, where applicable, an AI-generated score.

The server also generates prompt sentences for question candidate information. In one example, the server creates a prompt sentence such as:

“Based on this candidate profile and the job requirements, generate 10 specific interview questions that a hiring manager should ask. Focus on verifying sales performance, leadership ability, and fit to company culture. Candidate profile: sales experience 5 years; leadership skills present. Requirements: minimum 3 years of sales experience; leadership preferred.”

The server sends the prompt sentence to the generative AI model. The model produces multiple question sentences, which the server parses into separate entries. The server associates each question with one or more categories (e.g., sales performance, leadership, cultural fit) by applying keyword matching or an additional classification model and stores the question candidate information in the storage device. By generating prompt sentences from internal structured data, the server constrains the generative AI model's behavior, improves reproducibility of outputs, and enables more efficient verification and association of generated outputs with stored records, thereby improving computer-implemented management of data.

The server further processes audio information acquired during interviews. The server receives audio information from the terminal and stores the raw audio data. The server applies speech recognition processing by invoking an automatic speech recognition engine. In one embodiment, the engine uses a neural acoustic model (e.g., a convolutional or recurrent network) coupled with a language model (e.g., a transformer-based sequence model), trained with a loss function such as connectionist temporal classification or sequence-to-sequence cross-entropy. The server converts the audio waveform into a sequence of feature vectors, such as Mel-frequency cepstral coefficients, and passes the vectors to the acoustic model. The engine outputs text information representing the recognized words and, in some embodiments, time stamps and speaker identifiers. The server normalizes the text information, merging segments, correcting obvious recognition artifacts using a post-processing rule set, and stores the normalized transcript.

The server generates interview record information by constructing a prompt sentence that instructs the generative AI model to produce structured minutes. In one example, the server creates a prompt sentence such as:

“Summarize the following job interview transcript into structured meeting minutes. Include sections: Summary, Candidate Strengths, Concerns or Risks, and Recommendation. Transcript: [interview transcript text].”

The server passes this prompt sentence and the transcript text to the generative AI model. The model outputs text in which headings and bullet points are delineated, and the server optionally normalizes the structure into a predefined format. By using structured prompt sentences that explicitly specify section headings and required content, the server obtains interview record information that can be easily parsed and indexed, reducing search time and memory access overhead when users later retrieve interviews.

The terminal displays suitability information, evaluation explanation information, question candidate information, and interview record information received from the server. The terminal renders the information using a graphical user interface framework. The terminal may allow the user to select particular question candidates, add manual notes to interview record information, and request re-evaluation under updated requirements. The terminal transmits any modifications back to the server, which updates the corresponding structured information in the storage device.

The described configuration yields technical effects that go beyond mere automation of human thought processes. By applying image processing before optical character recognition, the server reduces OCR error rates, leading to higher-quality text information that requires fewer correction passes and re-processing operations, thereby improving processing throughput and reducing computational load. By converting both applicant information and requirement information into structured information with normalized fields and indices, the server avoids repeated ad-hoc parsing, reduces redundant computations, and supports cache-friendly data access patterns, thereby improving memory utilization and latency. By generating prompt sentences from internal structured information and by constraining generative outputs to specified formats, the server maintains a tight coupling between deterministic modules and generative modules, enabling the system to systematically store, retrieve, and reuse generated outputs in an indexed form. This reduces communication overhead with external generative AI services, improves predictability of output length and content, and facilitates effective caching of generative results.

In addition, the server uses specific algorithmic rules and weighting schemes for suitability calculation that are not a human-like free-form judgment but an engineered scoring function designed to be efficiently computed in a computational environment. The server's combination of neural network components (OCR recognition network, speech recognition network, generative transformer network) with rule-based normalization, structured data schemas, and weighted comparison logic yields lower end-to-end error rates and reduced processing time for large volumes of applicants compared with naïve text-only or unstructured approaches.

In another embodiment, the server employs a different generative AI model architecture, such as a recurrent neural network with attention, or a smaller on-premises language model, while keeping the same structured prompt sentence generation logic. In yet another embodiment, the server replaces the OCR engine with a different character recognition algorithm or a different image processing library, or uses alternative speech recognition engines, while preserving the data flow in which image information and audio information are converted into structured information and then used to construct prompt sentences. The server may store structured information in either relational databases or document-oriented databases while applying the same suitability evaluation and prompt generation algorithms.

In all these embodiments, the server, the terminal, and the user cooperate in a technical system where the server transforms noisy, heterogeneous input data from physical sensors (camera and microphone) into machine-optimized structured information and controlled generative outputs. This architecture improves recognition accuracy, computational efficiency, and data management inside the computer system, and thereby provides a concrete improvement in computer functionality rather than merely implementing an abstract business method.

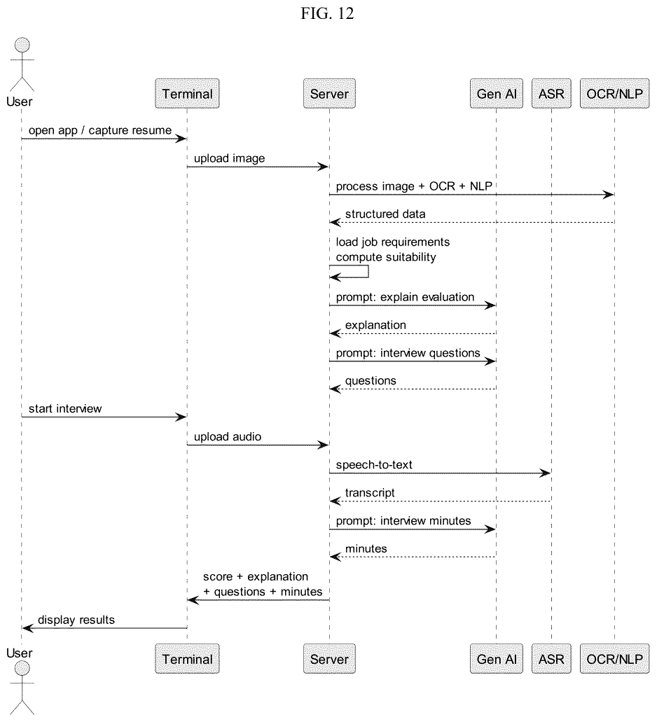

The following describes the processing flow using FIG. 12.

### Step 1

The user operates the terminal to launch an application and select an option to capture a resume or work history document.

Input: A physical document containing personal history information and work history information.

Output: Digital image information buffered in the terminal.

The terminal activates a camera device via an operating system API, displays a live preview, and adjusts exposure and focus parameters based on sensor readings. The user aligns the document within a frame shown on the display and triggers a capture operation. The terminal samples sensor data from the camera, converts analog light signals into pixel values through an image signal processor, and encodes the resulting image in a format such as JPEG or PNG. The terminal stores the encoded image information temporarily in local memory.

### Step 2

The terminal transmits the captured image information to the server via a network.

Input: Encoded image information stored in the terminal.

Output: Encoded image information received and stored on the server.

The terminal generates a request message containing the image information and metadata such as applicant identifier, timestamp, and document type. The terminal uses a network stack to encapsulate the data in a secure protocol, such as HTTPS, and sends packets to the server. The server receives network packets, reconstructs the request message, and writes the image information to a storage device with an associated identifier.

### Step 3

The server performs image processing to generate processed image information optimized for optical character recognition.

Input: Raw image information stored on the server.

Output: Processed image information suitable for OCR.

The server loads the image information from the storage device into main memory and invokes an image processing library. The server converts the color image to grayscale by computing weighted sums of color channels, applies a thresholding algorithm to produce a binary image, and executes a noise reduction filter such as a Gaussian blur or median filter to remove isolated pixel noise. The server analyzes the pixel distribution to detect skew angles by computing the orientation of long edges or text baselines, and rotates the image to correct for skew. The server optionally segments the image into text regions by running a connected component analysis and bounding box extraction. The server outputs processed image information in memory and stores it if needed for traceability.

### Step 4

The server executes optical character recognition processing to extract text information from the processed image information.

Input: Processed image information.

Output: Text information representing recognized characters and layout.

The server passes the processed image information to an OCR engine. The OCR engine divides the image into smaller patches, extracts visual features such as gradient histograms and edge orientations, and feeds the features into a trained neural network classifier that outputs character probabilities. The server applies a decoding step that selects the most probable character sequence, combines characters into words based on spacing and segmentation, and reconstructs line and paragraph structure using layout analysis. The server creates text information as a sequence of characters and line breaks and stores this text information in the storage device linked to the source document identifier.

### Step 5

The server applies natural language processing to generate structured information from the text information.

Input: Text information obtained from OCR.

Output: Structured information including ability information and experience information.

The server loads the text information into memory and invokes an NLP pipeline. The server tokenizes the text into word units, assigns part-of-speech tags to each token, and computes dependency relations among tokens. The server identifies named entities corresponding to skills, job titles, organization names, and time periods by applying a sequence labeling model.

The server applies pattern rules to detect phrases such as “5 years of sales experience” by locating numeric tokens followed by time units and domain terms. The server constructs structured information in the form of records containing fields such as skill identifiers, normalized years of experience, industry categories, and educational levels. The server writes this structured information into a database indexed by applicant identifier.

### Step 6

The server retrieves requirement information and calculates suitability information based on the structured applicant information.

Input: Structured applicant information and requirement information stored on the server.

Output: Suitability information including at least a numerical score and a categorical label.

The server reads requirement records corresponding to a specified position, including required skills, preferred skills, and minimum experience thresholds. The server matches required and preferred skills against the structured applicant information by comparing normalized skill identifiers and computing match flags. The server calculates partial scores for required skills, preferred skills, and experience duration using predefined weighting coefficients. The server sums the partial scores to produce a raw suitability value and normalizes the value into a score range, for example 0 to 100. The server assigns a label such as “high,” “medium,” or “low” by comparing the normalized score to threshold values. The server stores the suitability information for later retrieval.

### Step 7

The server generates a prompt sentence for a generative AI model to produce evaluation explanation information.

Input: Structured applicant information, requirement information, and suitability information.

Output: A prompt sentence formatted for the generative AI model.

The server composes a textual description of the applicant's structured data, including skills, years of experience, and industries, and a description of the requirement information, including required and preferred skills and thresholds. The server embeds the suitability score into the description if available. The server arranges these elements into a prompt sentence, for example:

“You are an assistant that evaluates candidates for a retail position. Here is the candidate's structured resume data: skills: sales, leadership; years of sales experience: 5; industries: retail. Here are the store's requirements: required skills: sales; minimum years of sales experience: 3; preferred skill: leadership. Evaluate whether the candidate fits the store's needs. Provide a suitability score from 0 to 100 and a short explanation.”

The server outputs the complete prompt sentence as text and forwards it to the generative AI model.

### Step 8

The server obtains evaluation explanation information from the generative AI model based on the prompt sentence.

Input: Prompt sentence containing structured applicant and requirement information.

Output: Evaluation explanation information, and optionally a refined score.

The server transmits the prompt sentence to the generative AI model as a sequence of tokens. The generative AI model processes the tokens through multiple transformer layers, computing attention scores and hidden representations at each layer. The model generates output tokens corresponding to a natural language explanation and, in some cases, a numerical score. The server receives the output token sequence, decodes it into text, and separates the explanation portion and any numerical value using pattern matching. The server stores the evaluation explanation information in the database, associated with the applicant and the computed suitability information.

### Step 9

The server generates a prompt sentence for the generative AI model to create question candidate information.

Input: Structured applicant information and requirement information.

Output: A prompt sentence requesting interview questions.

The server selects key fields from the structured information that indicate strengths or gaps, such as high sales experience and presence of leadership skills, and combines them with the most critical requirement fields. The server builds a textual instruction, for example:

“Based on this candidate profile and the job requirements, generate 10 specific interview questions that a hiring manager should ask. Focus on verifying sales performance, leadership ability, and fit to company culture. Candidate profile: sales experience 5 years; leadership skills present. Requirements: minimum 3 years of sales experience; leadership preferred.”

The server outputs this instruction as a prompt sentence and sends it to the generative AI model.

### Step 10

The server obtains question candidate information from the generative AI model and structures it for storage.

Input: Prompt sentence requesting interview questions.

Output: Question candidate information stored as structured entries.

The server receives a sequence of text representing multiple questions from the generative AI model. The server splits the text into individual questions using delimiters such as newlines or numbering patterns. The server optionally applies keyword matching or classification rules to assign categories to each question, such as “sales performance,” “leadership,” or “culture fit.”

The server creates structured records for each question, including text content and category labels, and stores these records in the database linked to the corresponding applicant and job identifier.

### Step 11

The terminal captures audio information during an interview and sends it to the server.

Input: Spoken dialogue between the user and an applicant.

Output: Encoded audio information transmitted to the server.

The terminal activates the microphone and configures sampling parameters such as sampling rate and bit depth. The terminal periodically reads audio samples from the microphone buffer, compresses the samples into an audio format, and writes them to a local file. When the interview ends, the user stops recording, and the terminal finalizes the audio file. The terminal constructs a network request containing the audio file and associated metadata and sends the request to the server, which receives and stores the audio information.

### Step 12

The server performs speech recognition processing on the audio information to obtain text information.

Input: Audio information representing the interview.

Output: Text information representing transcribed speech.

The server loads the audio information and passes it to a speech recognition engine. The engine converts the audio signal into frames and calculates acoustic features such as Mel-frequency cepstral coefficients for each frame. The engine feeds the feature sequence into an acoustic model and decodes the resulting probability distributions using a language model to generate a word sequence. The server receives the transcribed text, optionally with time stamps and speaker labels, and normalizes spelling, punctuation, and spacing. The server stores the normalized transcript as text information in the database.

### Step 13

The server generates a prompt sentence for the generative AI model to create interview record information.

Input: Text information representing the interview transcript.

Output: A prompt sentence requesting structured meeting minutes.

The server embeds the transcript text into an instruction that specifies the desired structure of the minutes. The server produces a prompt sentence such as:

“Summarize the following job interview transcript into structured meeting minutes. Include sections: Summary, Candidate Strengths, Concerns or Risks, and Recommendation. Transcript: [interview transcript text].”

The server outputs this prompt sentence and sends it to the generative AI model.

### Step 14

The server obtains interview record information from the generative AI model and formats it for presentation and storage.

Input: Prompt sentence including the interview transcript.

Output: Interview record information in a structured textual format.

The server receives a generated text containing headings and summaries from the generative AI model. The server parses the generated text to identify section headers corresponding to “Summary,” “Candidate Strengths,” “Concerns or Risks,” and “Recommendation.” The server organizes the content under each section into separate fields in a structured record and stores the interview record information in the database. The server prepares display-ready versions of the minutes, such as formatted text or markup, for subsequent transmission.

### Step 15

The server transmits evaluation and record information to the terminal for display to the user.

Input: Suitability information, evaluation explanation information, question candidate information, and interview record information stored on the server.

Output: Display information rendered on the terminal.

The server retrieves the stored information corresponding to a selected applicant, aggregates the suitability score, explanation, questions, and minutes into a response object, and formats it as a message suitable for network transmission. The server sends the response to the terminal. The terminal receives the data, parses the content, and renders the information in separate views, such as an evaluation summary screen, a question list screen, and a minutes screen. The user views and interacts with these outputs to support decision-making, while the server and terminal handle the underlying data processing and presentation.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional interview support workflows rely on disparate software components and manual operations for processing applicant documents and interview records. In typical systems, resume and curriculum vitae documents are digitized and stored, but the extraction of meaningful organization attributes, work history details, and interview focus points is performed by human operators. Likewise, automatic speech recognition can convert interview audio into raw text, but the subsequent structuring of that text into useful interview minutes is often left to manual editing. As a result, the overall process is labor-intensive, prone to inconsistency, and dependent on individual operator skill.

From a computer technology perspective, existing systems do not provide an integrated, processor-controlled pipeline that: (i) acquires heterogeneous input data (image-based and text-based documents, and audio), (ii) normalizes and structures such data using a combination of optical character recognition, natural language processing, and generative AI, and (iii) automatically generates downstream artifacts such as interview question lists and interview minutes in a machine-usable form. In many cases, generative AI models are invoked in an ad hoc manner by end users, without standardized prompt generation, without systematic linkage to structured data derived from resumes, and without consistent association of generated outputs with underlying records in a storage subsystem. This leads to inefficient utilization of computing resources, redundant computations, and difficulty in reproducing or auditing the generated outputs.

Furthermore, traditional architectures do not optimize the interaction between natural language processing components and generative AI models. Raw text is often passed directly to a generative model without prior structuring, causing the model to process noisy or irrelevant content, increasing computational load and latency, and sometimes producing unstable or inconsistent question sets and summaries. There is also a lack of coordinated control logic in the processor for generating prompt sentences that explicitly encode structured attributes and work history, resulting in suboptimal guidance to the generative AI model and reduced quality of the generated interview questions and interview records.

In addition, existing systems typically treat document processing and audio processing as separate, loosely coupled functions. There is no unified control flow in which a processor systematically acquires applicant documents, extracts and structures data, generates interview questions, captures interview audio, and then uses both natural language processing and generative AI to generate interview record information and summaries that are consistently linked to the previously generated question information. Consequently, the system is not optimized as a whole: database schemas are underutilized, cross-referencing between data objects is weak, and downstream applications cannot reliably leverage prior structured information.

Accordingly, there is a need for an improved computer-implemented system that configures a processor to orchestrate, in an integrated manner, document acquisition, character extraction, natural language analysis, prompt sentence generation, interaction with a generative AI model, question list presentation, audio transcription, and interview record generation. Such a system should improve the efficiency, reliability, and consistency of the data processing pipeline itself, reduce manual intervention, and enhance the technical performance of the underlying computing platform in terms of resource utilization, latency, and data organization.

The specific processing by the specific processing unit 290 of the data processing device 12 in Example 2 is realized by the following means.

The present invention provides a server comprising a processor and a storage device, the processor being configured to acquire document data including applicant career information from an image acquisition device or an information processing terminal, extract character information from the acquired document data by using optical character recognition technology or document analysis technology and convert the extracted character information into digital text data, apply natural language processing technology to the converted digital text data to extract organization attribute information and work history information of an applicant and generate structured information including the organization attribute information and the work history information, generate a prompt sentence for causing a generative AI model to generate question information including matters to be confirmed in an interview based on the structured information, input the prompt sentence into the generative AI model to obtain output information including the question information, transmit the obtained question information to the information processing terminal and cause the information processing terminal to present the question information as an interview preparation question list, convert audio data acquired during the interview into text data by using speech recognition technology, and automatically generate interview record information from the text data by using natural language processing technology or the generative AI model, and further configured to format the extracted character information into a predetermined format and store, as structured data in the storage device, at least the organization attribute information, the work history information, the question information, the interview record information, and summary information generated by the generative AI model based on a prompt sentence including at least a part of the organization attribute information and the work history information. This enables an integrated, processor-controlled data processing pipeline that structurally links document-derived applicant information, automatically generated interview questions, and interview record information, thereby improving computational efficiency, reducing manual operations, enhancing the consistency and reproducibility of generative AI outputs, and optimizing the overall performance of the computer system in executing interview support workflows.

The term “processor” refers to a hardware computation unit, such as a central processing unit or a graphics processing unit, that executes instructions to perform the data acquisition, analysis, generation, and storage operations described herein.

The term “storage device” refers to a hardware memory component, such as a magnetic disk, solid-state drive, or semiconductor memory, that persistently stores digital data including structured information, question information, interview record information, and summary information.

The term “image acquisition device” refers to an apparatus configured to capture image data of a document, such as a scanner, digital camera, or image sensor-equipped terminal.

The term “information processing terminal” refers to an electronic device, such as a personal computer, tablet, or smartphone, that is capable of transmitting and receiving data to and from the server and presenting information to a user through an input/output interface.

The term “document data” refers to digital information representing a document including applicant career information, such as a resume, curriculum vitae, or similar employment-related record in image or text form.

The term “applicant career information” refers to information describing an individual's professional background, including employment history, job roles, responsibilities, skills, educational background, and related qualifications.

The term “character information” refers to symbol-level textual content obtained from document data, including letters, numbers, punctuation marks, and other glyphs that can be converted into digital text data.

The term “digital text data” refers to character information represented in a machine-readable text format, which can be processed by software components such as natural language processing modules and generative AI models.

The term “optical character recognition technology” refers to a software-implemented technique that analyzes image data to detect and recognize characters and words, and converts them into corresponding digital text data.

The term “document analysis technology” refers to software-implemented processing that extracts textual and structural information from non-image document formats, such as electronic documents, by parsing embedded content.

The term “natural language processing technology” refers to a set of software-based techniques for analyzing, interpreting, and manipulating human language text, including tokenization, part-of-speech tagging, entity recognition, classification, and summarization.

The term “organization attribute information” refers to information describing characteristics of an organization associated with the applicant, such as industry sector, business type, scale, technology domain, and other organizational properties.

The term “work history information” refers to structured information describing the applicant's employment periods, positions, responsibilities, projects, and technical skills across one or more organizations.

The term “structured information” refers to data organized according to a predefined schema or data model, such as records containing fields for organization attributes, work history items, and related metadata.

The term “prompt sentence” refers to a machine-readable textual instruction generated by the processor for input to a generative AI model, the instruction specifying how the model should process given information and what type of output should be generated.

The term “generative AI model” refers to a software-implemented artificial intelligence model configured to generate new text data, such as question information, interview record information, or summary information, based on input text including a prompt sentence and associated content.

The term “question information” refers to data representing one or more interview questions, including text questions and optionally associated metadata such as category, priority, or target competency.

The term “matters to be confirmed in an interview” refers to topics or points to be examined during an interview, such as technical skills, professional experience, behavioral traits, and organizational fit.

The term “output information” refers to text data generated by the generative AI model in response to a prompt sentence, including at least question information or summary information.

The term “interview preparation question list” refers to a collection of question information organized for use by an interviewer prior to or during an interview.

The term “audio data” refers to digitized acoustic signals captured during an interview, representing spoken utterances of one or more participants.

The term “speech recognition technology” refers to a software-implemented technique that converts audio data containing speech into corresponding digital text data by detecting and recognizing spoken words.

The term “interview record information” refers to text data describing the content of an interview, including summaries, key points discussed, decisions, and other relevant details derived from interview audio or transcripts.

The term “summary information” refers to condensed text generated from more detailed structured information or transcript data, highlighting main points such as key aspects of organization attribute information and work history information.

The term “data management apparatus” refers to a computing system including the processor and the storage device, configured to manage, store, and retrieve structured data related to applicant information and interview-related information.

In one embodiment, a server cooperates with a terminal operated by a user to perform integrated processing of applicant documents and interview audio. The server includes a processor and a storage device. The processor executes a plurality of software modules including a web application module, an optical character recognition (OCR) module, a document parsing module, a natural language processing (NLP) module, a generative AI interface module, a speech recognition interface module, and a data management module. The storage device stores document data, intermediate structured information, prompt sentences, generated question information, interview record information, and summary information.

The server is implemented, for example, on a general-purpose computing platform such as a rack-mounted server or a virtual machine instance provided by a cloud computing service. The server uses a central processing unit and, optionally, a graphics processing unit for accelerating neural network computations. The server executes an operating system such as a general-purpose server operating system, and runs an application framework such as a web server and an application server framework. The OCR module uses a character recognition engine such as an open-source OCR engine or a cloud-based OCR service. The NLP module and the generative AI interface module use machine learning libraries such as a transformer library, a neural network library, and a numerical computation library. The speech recognition interface module connects to a speech-to-text engine such as a neural-network-based speech recognizer.

The terminal is implemented as a personal computer, a tablet, or a smartphone. The terminal runs a web browser or a native application. The terminal includes an input component such as a keyboard or touch panel and an audio input component such as a microphone. The terminal displays graphical user interface (GUI) screens for uploading documents, viewing generated question lists, and reviewing interview record information.

The user operates the terminal to select applicant documents such as resumes and curriculum vitae. The terminal transmits the selected files to the server over a network using a secure communication protocol. The server receives the files and stores them in the storage device. The server determines a file type of each document. When the file type is an image-based format, the OCR module reads bitmap data, segments potential character regions, and applies a convolutional neural network classifier to recognize character glyphs. When the file type is a text-based format, the document parsing module reads the file structure and extracts embedded text with layout information.

The server converts the recognized characters and extracted text into unified digital text data, normalizing character encoding and removing non-text control symbols. The NLP module applies tokenization by using a transformer-compatible tokenizer to split the text into tokens. The NLP module applies sentence segmentation and part-of-speech tagging. The NLP module then performs named entity recognition using a pre-trained transformer-based sequence labeling model, which is configured with a multi-layer self-attention architecture and trained to output entity labels such as organization, job title, time period, and skill.

The server groups the recognized entities into structured information that represents organization attribute information and work history information. For example, the server associates organization names with industry labels and technology domains by applying a classifier that operates over token embeddings output by the transformer model. The classifier uses a feed-forward neural network with softmax output to assign category labels. The server further infers durations and seniority levels by applying rule-based logic to time expressions and job title patterns. The server stores the resulting structured information in a relational database in records that include fields for organization attributes, roles, durations, responsibilities, and technical skills.

The server generates a prompt sentence for a generative AI model by applying a template-based prompt construction algorithm. The server selects fields from the structured information and inserts them into predefined textual templates. The generative AI interface module concatenates text segments such as role descriptions, duration, industry, and technology stack into a coherent instruction. For example, the server generates a prompt sentence such as:

“You are an interviewer. Based on the following applicant profile, generate 10 detailed interview questions.

### Applicant Profile

Role: Software Engineer
Work experience: 5 years
Industry: IT company providing cloud services
Tech stack: AWS, Java, Kubernetes

Focus on scalability, reliability, programming language choice, and system design.

Output the questions as a numbered list.”

The server counts the number of tokens of the prompt sentence by using the tokenizer associated with the generative AI model to ensure that the combined prompt and expected output fit within a token limit. When the server detects that the prompt is too long, the server truncates low-priority details according to defined rules that assign weight values to each field.

The server then transmits the prompt sentence to the generative AI model through an application programming interface. The generative AI model is implemented, for example, as a transformer-based language model with multiple self-attention layers, feed-forward layers, and positional encoding. The generative AI model has been trained in advance on large-scale text data by minimizing a prediction error function such as cross-entropy loss between predicted token distributions and ground-truth tokens. During training, the model parameters are updated by a gradient-based optimization algorithm such as stochastic gradient descent with adaptive learning rate, and regularization methods such as dropout and layer normalization are applied. Data augmentation techniques such as masking, shuffling, or synthetic question generation can be applied to improve robustness.

The server receives output information from the generative AI model, which contains question information as a text sequence. The NLP module parses the output sequence and splits it into individual questions by detecting numbering markers or line breaks. The server removes malformed or duplicate questions by applying string similarity measures and pattern matching. The server assigns metadata such as category (technical, behavioral, organizational) by applying a classifier that evaluates each question text using an embedding vector and a softmax decision boundary.

The server stores the question information as structured records, linking the questions to the underlying applicant structured information. The data management module maintains indexes and foreign-key relationships between applicant profiles, question lists, and subsequent interview records. This specific data organization enables efficient retrieval and reuse, reduces redundant computation, and provides a basis for auditing the generative AI output.

The terminal requests the generated question list from the server and displays it in a GUI. The user reviews the questions on the terminal and may add manual annotations or reordering. The terminal sends these adjustments back to the server, and the server updates the corresponding records. Because the server maintains a consistent structured representation, subsequent processing such as scoring or filtering can be performed efficiently.

The user conducts an interview and uses the terminal to record audio via the microphone. The terminal transmits the audio data to the server. The server passes a reference to the audio file to the speech recognition interface module. The speech recognition engine uses an acoustic model, such as a deep neural network trained on speech signals, and a language model to decode the audio into text. The server receives a transcript as digital text data and stores it in association with the question list for that interview.

The server generates a prompt sentence for creating interview record information from the transcript. For example, the server generates a prompt sentence such as:

“You are an assistant that creates interview minutes.

Below is the full transcript of an interview between an interviewer and a job applicant.

Please generate concise interview minutes including:
1. Summary of the candidate's background
2. Key technical topics discussed
3. Strengths and weaknesses
4. Open questions and next steps.

### Transcript

[insert transcript text here]”

The server again applies token counting and truncation rules to ensure that the transcript portion of the prompt is within acceptable size limits. The server can segment the transcript into segments and process them sequentially, merging partial summaries by a subsequent summarization step that uses the generative AI model with a separate merging prompt.

The generative AI model processes the prompt sentence and transcript and outputs structured interview record information. The server parses headings and bullet points in the output text to create structured records representing summary sections, technical topic lists, positive indicators, risks, and recommended actions. The server stores these records in the database with links to the original transcript and question list. This linkage improves data management and allows queries that correlate questions asked with candidate responses and evaluation metrics.

In another embodiment, the server generates summary information of the applicant profile before the interview. The server constructs a prompt sentence that summarizes organization attribute information and work history information. For example, the server generates a prompt such as:

“Based on the applicant's work history below, generate a concise summary focusing on industry experience, key technologies, and major responsibilities.

### Work History

[insert structured work history text here].”

The generative AI model produces summary information, which the server stores along with the question information. The terminal can display this summary on a dashboard prior to the interview, allowing a user to quickly understand the applicant's background with reduced cognitive load.

The server achieves technical improvement of computer operation by structuring unstructured text before invoking the generative AI model. By extracting organization attributes and work history information via the NLP module and storing them as structured information, the server reduces the amount of irrelevant or redundant text passed to the generative AI model, thereby reducing required computation, decreasing latency, and improving the stability of the generated question set. The token-reduction process, which is based on explicit weighting rules and field selection, constitutes a non-conventional data pre-processing pipeline tuned to the constraints of a transformer-based model. This pipeline improves the throughput of the server in multi-user environments and reduces network traffic between the server and external AI services by minimizing payload size.

The server further improves accuracy and consistency by using dual-stage processing: a deterministic NLP module for entity extraction and a generative AI module for question and summary generation. The deterministic module uses clearly defined feature extraction mechanisms and model parameters, while the generative module is constrained by prompt sentences that encode structured fields and requested output format. This combination reduces hallucination by the generative AI model and yields more predictable outputs. From a computer technology standpoint, such a coordinated control of two different types of models, implemented via explicit data structures and prompt generation algorithms, provides a technical solution beyond simple human replacement.

The server can implement alternative embodiments in which different neural network architectures or training methods are used. In one variation, the server uses a bidirectional encoder model, such as a transformer encoder, for entity extraction, and uses an autoregressive decoder-only model for question generation. In another variation, the server uses a sequence-to-sequence model with attention for both summarization and question generation. The server can also fine-tune the generative AI model using domain-specific interview datasets. During fine-tuning, the server computes a loss function such as cross-entropy over token sequences representing high-quality interview questions and minutes, and updates model weights using mini-batch gradient descent. The server may apply data augmentation by paraphrasing questions or inserting controlled noise to improve robustness.

The server uses specific data structures to manage content. For example, the server stores each applicant profile as a record with fields including a unique identifier, normalized name, list of organization entries, and list of skills. Each organization entry includes subfields for organization name, industry code, size code, start date, end date, position title, and associated skills. Question records reference the applicant identifier and include fields for question text, category code, generation timestamp, and prompt identifier. Interview record records reference both applicant and question identifiers and include text fields for summary sections. This structured design allows efficient joins and indexing, improving retrieval speed and reducing storage overhead by avoiding duplication of repeated information.

The server applies non-conventional rule sets for mapping entity patterns to structure. For example, when the NLP module detects a sequence “Senior Backend Engineer at a cloud service provider for 5 years,” the server applies rules that parse “Senior Backend Engineer” into a role class and seniority level, map “cloud service provider” to standardized industry and technology codes, and interpret “5 years” as a duration field. These rules are implemented as a combination of regular expressions and decision trees that operate on tags output by the NLP model. This rule-based post-processing constitutes a distinct computational step that transforms raw model outputs into highly structured, machine-friendly representations.

The server thereby provides technical effects such as improved processing speed by reducing unnecessary generative AI calls, improved accuracy and consistency of question generation by constraining inputs and outputs, improved data management through normalized schemas and cross-linked records, and reduced communication load by compressing and structuring content before transmission. These effects arise from the specific data flows, model interactions, and algorithmic rules implemented within the server, and are not achieved by mere manual operations or simple automation of human tasks.

The user, through the terminal, benefits from reduced waiting time due to optimized model invocation, and from improved quality of generated questions and interview records owing to the structured use of applicant data. The terminal displays processed information that has been computed by the server using the above-described technical mechanisms, and does not simply mirror raw human input. Thus, the system realizes a concrete improvement in computer functionality and data processing, supporting the implementation of the claimed invention.

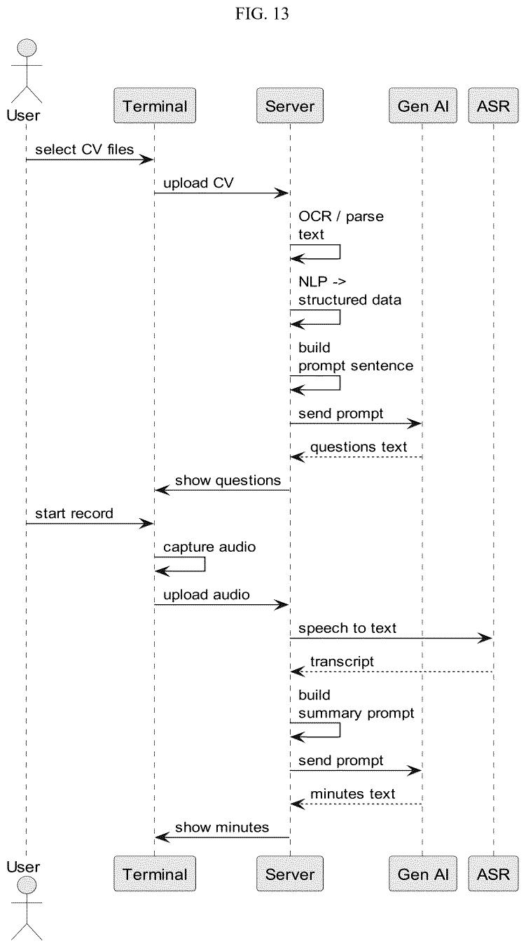

The following describes the processing flow using FIG. 13.

### Step 1

The user operates the terminal to select applicant documents such as a resume and a curriculum vitae stored in local storage.

The terminal receives the user's selection as input and packages the selected files into an HTTP request.

The terminal transmits the HTTP request, including the document data as multipart/form-data, to the server over a network.

The output of this step is an HTTP upload request containing the raw document data.

### Step 2

The server receives the HTTP request from the terminal as input through a web server component.

The server parses the request, extracts the attached files, and stores the raw document data in a storage device with unique identifiers.

The server writes metadata records into a database, including file paths, file types, and association with a particular applicant.

The output of this step is stored raw document data and corresponding metadata entries in the database.

### Step 3

The server reads the stored document data and metadata as input.

The server determines the document format (for example, image-based or text-based) by inspecting file headers and extensions.

The server routes image-based files to an OCR module and text-based files to a document parsing module.

The output of this step is a processing plan that associates each document with a selected extraction method.

### Step 4

The server provides image-based document data as input to the OCR module.

The server uses optical character recognition technology to segment regions of interest, classify glyphs, and decode characters, thereby generating raw text strings from bitmap data.

The server normalizes the recognized text by converting encoding to UTF-8, removing extraneous whitespace, and correcting simple recognition errors using dictionary-based rules.

The output of this step is normalized digital text data derived from image-based documents.

### Step 5

The server provides text-based document data (such as digital PDF or text files) as input to the document parsing module.

The server uses document analysis technology to extract embedded text streams, remove layout control characters, and reconstruct logical reading order.

The server concatenates multi-page text segments, performs normalization similar to the OCR case, and merges them into a single text block per document.

The output of this step is normalized digital text data derived from text-based documents.

### Step 6

The server combines the normalized text outputs from the OCR module and the document parsing module as input to the NLP module.

The server tokenizes the combined text into tokens and sentences, and performs part-of-speech tagging and named entity recognition using a transformer-based model.

The server identifies entities such as organization names, job titles, periods, and skill names, and assigns labels to each token sequence.

The output of this step is annotated text data in which tokens are tagged with entity and syntactic information.

### Step 7

The server takes the annotated text data as input and constructs structured information records.

The server groups entities by temporal and organizational context to form work history entries, and infers organization attribute information such as industry and technology domain using classification rules and learned models.

The server writes the resulting structured information, including organization attributes and work history information, into database tables with defined schemas.

The output of this step is a set of structured database records representing the applicant's profile.

### Step 8

The server takes the structured information as input for prompt construction.

The server selects relevant fields (for example, role, duration, industry, and tech stack) and inserts them into a predefined text template to generate a prompt sentence for a generative AI model.

The server uses a tokenizer to count tokens in the generated prompt and applies truncation or field prioritization rules if the token count exceeds a predefined limit.

The output of this step is a finalized prompt sentence designed to cause the generative AI model to generate interview question information.

### Step 9

The server sends the prompt sentence as input to the generative AI model through an external or internal API.

The server includes model parameters such as temperature and maximum output length, and transmits the request using a secure protocol.

The generative AI model processes the prompt and returns a text output containing candidate interview questions.

The output of this step is a raw text response from the generative AI model that includes question information.

### Step 10

The server takes the raw text response from the generative AI model as input.

The server splits the response into individual questions by parsing line breaks, numbering patterns, or bullet markers, and trims unnecessary whitespace and control characters.

The server removes duplicate or malformed questions by applying string similarity metrics and simple syntactic checks, and assigns category labels to each question using a lightweight classifier.

The output of this step is a cleaned and categorized list of interview questions stored as structured records in the database.

### Step 11

The server provides the structured question list as input to the web application module.

The server generates a response message including the question list in a machine-readable format and sends it to the terminal.

The terminal receives the question list, renders the questions in a GUI, and allows the user to scroll, select, or annotate the questions.

The output of this step is a displayed interview preparation question list on the terminal.

### Step 12

The user views the question list on the terminal and conducts the interview while referring to the displayed questions.

The user operates a recording control on the terminal to start audio capture.

The terminal uses a microphone to record audio, buffers the audio data in memory, and, at the end of the interview, uploads the recorded audio file to the server.

The output of this step is an audio file transmitted to the server, containing the interview conversation.

### Step 13

The server takes the uploaded audio file as input to the speech recognition interface module.

The server invokes a speech recognition engine, which analyzes the audio waveform, applies acoustic and language models, and produces a text transcript.

The server receives the transcript, performs basic cleanup such as removing filler words if configured, and stores the transcript in the database linked to the corresponding interview record.

The output of this step is a normalized text transcript of the interview.

### Step 14

The server uses the transcript as input to construct a prompt sentence for generating interview record information.

The server embeds the transcript into a summarization template that requests specific sections such as background summary, technical topics, strengths, weaknesses, and next steps, and applies token counting and segmentation rules if the transcript is long.

The server produces a summarization prompt sentence that combines instruction text and transcript segments in a controlled structure.

The output of this step is a summarization prompt sentence suitable for input to the generative AI model.

### Step 15

The server sends the summarization prompt sentence as input to the generative AI model.

The server receives the generated output text including structured interview record information, such as section headings and bullet lists, from the generative AI model.

The server parses the generated text, identifies section boundaries, and maps them into database fields such as summary, key topics, strengths, weaknesses, and action items.

The output of this step is a structured set of interview record information stored in the database.

### Step 16

The server retrieves the structured interview record information as input to a presentation module.

The server composes a response payload including the record information and sends it to the terminal upon request by the user.

The terminal displays the interview minutes in a readable layout, and the user can review, edit, and confirm the content, with any edits sent back to the server for storage.

The output of this step is a finalized, stored interview record that integrates transcript-derived information and generative AI-based summarization.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional interview support systems and document processing systems have several technical limitations when implemented on general-purpose computer architectures. First, known resume and work-history parsers typically perform only shallow keyword extraction, without generating structured, machine-usable representations that are tightly integrated with downstream dialog support. As a result, processors and memory subsystems are not used efficiently to derive context-aware interview questions, and the burden of synthesizing effective questions remains with human operators. This leads to repeated manual navigation of large text corpora, redundant computations, and suboptimal utilization of available processing resources.

Second, existing automatic speech recognition and logging tools generally capture interview audio and convert it to linear text transcripts, but they do not integrate real-time emotion analysis with transcript generation and do not feed such analysis back into the running human-machine interaction loop. In typical systems, audio processing, text processing, and any sentiment analysis are siloed components, loosely coordinated by application code. This fragmented architecture causes duplicated data transfers between memory and storage units, inefficient use of accelerators, high latency in generating helpful feedback, and poor scalability when multiple sessions are processed in parallel.

Third, conventional systems that use generative AI models often treat prompt creation as a static or manually defined configuration, rather than as a dynamically computed artifact based on structured resume data, evolving transcripts, and emotion time-series data. This leads to under-utilization of the generative model's capabilities and forces repetitive, ad-hoc invocations that do not adapt to the actual state of the interaction. From a computer-technology perspective, this means the processor does not exploit available context signals to optimize its calls to remote inference services, resulting in unnecessary network communication, increased latency, and less effective caching and reuse of intermediate results.

Fourth, post-interview record generation in many systems is implemented as a batch export of raw text, without intelligent organization into sections, linkage to underlying structured data, or association with emotion trajectories. Consequently, the storage subsystem maintains heterogeneous, weakly related blobs (documents, logs, analytics outputs) that cannot be efficiently queried or recombined. This leads to higher storage overhead, higher indexing cost, and more complex retrieval logic, which in turn increases CPU usage and degrades responsiveness of user interfaces.

Therefore, there is a need for an improved computer-implemented system and associated processing architecture that: (i) unifies optical character recognition, natural language processing, emotion analysis, and generative AI invocation around a shared structured data model; (ii) dynamically constructs prompt sentences for a generative AI model based on resume-derived data, live transcript segments, and emotion time-series information; and (iii) automatically generates and stores interview record documents and follow-up question sets in a manner that reduces redundant computation, minimizes data movement, lowers end-to-end latency, and improves the overall efficiency and quality of interview support on a server-terminal configuration. By addressing these limitations at the level of how the processor orchestrates and coordinates these components, the invention aims to improve the functioning of the underlying computer system itself, rather than merely automating a human mental process.

The specific processing by the specific processing unit 290 of the data processing device 12 in Application Example 2 is realized by the following means.

The present invention provides a server comprising a processor configured to acquire visual information including image data of history information records via an imaging apparatus, convert character information included in the visual information into text information by optical character recognition processing, analyze the text information by natural language processing to extract affiliation organization information, duty information, and skill information, and identify items to be confirmed in an interview based on an extraction result; to generate a first prompt sentence on the basis of the affiliation organization information, the duty information, the skill information, and the items to be confirmed in the interview, to input the first prompt sentence to a generative AI model so as to cause the generative AI model to generate interview question information or summary information, and to transmit the interview question information to a terminal device for presentation on a user-oriented display screen; to acquire audio information of conversation speech in the interview from an acoustic sensor, convert the audio information into text information by speech recognition processing, execute emotion analysis processing on the basis of at least one of the audio information and the text information to estimate an emotional state and generate emotional time-series information indicating a temporal change of the emotional state; to generate a second prompt sentence for generating feedback information for an interviewer or additional interview question information on the basis of the emotional time-series information and the interview question information, to input the second prompt sentence to the generative AI model so as to cause the generative AI model to generate the feedback information or the additional interview question information, and to transmit a generation result to the terminal device; and to automatically generate an interview record document on the basis of the text information and the emotional time-series information and store the interview record document in a recording information storage unit, while formatting the text information and the extracted affiliation organization information, duty information, and skill information as structured data stored in an information storage apparatus and managing the structured data in association with the interview question information, the interview record document, and the emotional time-series information, and further analyzing the interview record document and the emotional time-series information to generate, via a third prompt sentence to the generative AI model, additional interview question information for a subsequent interview. This enables the server to coordinate optical character recognition, natural language processing, emotion analysis, and generative AI-based text generation within a unified processing pipeline, thereby reducing redundant computation, lowering latency of question and feedback generation during interviews, improving the organization and retrievability of interview-related data in storage, and enhancing overall efficiency and technical performance of the computer system in supporting interview workflows.

The term “visual information” refers to information represented in an image format, including pixel data of documents, such as resumes and work-history records, that contain character information to be processed by an image input device and an optical character recognition engine.

The term “history information records” refers to documents describing personal background information, including but not limited to education, employment history, roles, responsibilities, and skills of a subject individual.

The term “imaging apparatus” refers to a hardware device configured to capture visual information, such as a scanner, a digital camera, or an image sensor of a terminal, and to output the captured information as image data suitable for processing by a computer system.

The term “optical character recognition processing” refers to a computerized technique that analyzes visual information including characters, detects glyph shapes, and converts the detected characters into machine-readable text information.

The term “text information” refers to digital data representing characters, words, and sentences in a machine-readable format, obtained by converting visual information or audio information into textual form.

The term “natural language processing” refers to computerized analysis and manipulation of text information, including operations such as tokenization, part-of-speech tagging, entity extraction, and semantic analysis, in order to derive structured meaning from human language expressions.

The term “affiliation organization information” refers to structured data describing organizations to which a subject individual is or was affiliated, including attributes such as industry type, size, and role of the organization.

The term “duty information” refers to structured data describing work contents, responsibilities, and roles performed by a subject individual in one or more organizations.

The term “skill information” refers to structured data describing capabilities, competencies, technologies, and knowledge areas associated with a subject individual, as extracted from text information.

The term “items to be confirmed in an interview” refers to specific topics, questions, or points of interest determined by analysis of history information records and used as guidance for conducting an interview.

The term “prompt sentence” refers to a text sequence constructed to instruct a generative AI model to perform a particular task, the text sequence including context information and requested output format so that the generative AI model can generate interview question information, summary information, feedback information, or additional interview question information.

The term “generative AI model” refers to a machine-learned model, such as a large language model, configured to generate text or other content in response to input data including a prompt sentence.

The term “interview question information” refers to text data representing one or more questions to be asked in an interview, the questions being generated or refined by a generative AI model based on structured data and prompt sentences.

The term “summary information” refers to text data representing a condensed description of history information records, interview contents, or other related data, generated by a generative AI model or other processing.

The term “terminal device” refers to an information processing apparatus operated by a user, such as a portable communication device, a tablet, a personal computer, or a dedicated client device, which communicates with a server and presents information on a user-oriented display screen.

The term “user-oriented display screen” refers to a graphical user interface presented on a terminal device, configured to output text, symbols, and controls for human users, including but not limited to interview questions, feedback messages, and record summaries.

The term “audio information” refers to digital data representing sound signals, including speech signals captured during an interview or other conversational interaction.

The term “acoustic sensor” refers to a hardware component such as a microphone or an array of microphones that converts sound waves into audio information suitable for processing by a computer system.

The term “speech recognition processing” refers to computerized analysis that converts audio information representing speech into text information by recognizing linguistic units such as phonemes, words, and sentences.

The term “emotion analysis processing” refers to computerized processing that estimates an emotional state of a speaker on the basis of audio information, text information, or both, using one or more models trained to detect emotional features.

The term “emotional state” refers to an estimated psychological condition of a subject individual, such as calmness, nervousness, confidence, or anxiety, represented in a machine-usable form.

The term “emotional time-series information” refers to data representing how an estimated emotional state changes over time, including time-stamped emotion labels and associated intensity values.

The term “feedback information” refers to text or symbolic data generated for an interviewer or other user, indicating recommended actions, hints, or observations derived from analysis of interview contents and emotional time-series information.

The term “additional interview question information” refers to text data representing one or more supplementary questions to be used in the same or a subsequent interview, the supplementary questions being generated based on previous interview contents, history information records, or emotional time-series information.

The term “interview record document” refers to a structured or semi-structured digital document that summarizes and records contents of an interview, including at least a transcript, key questions and answers, and optionally emotional time-series information.

The term “recording information storage unit” refers to a storage component or subsystem, such as a memory device or an external storage device, configured to store interview record documents and related information.

The term “information storage apparatus” refers to a hardware and software combination that stores structured data, including but not limited to relational databases, key-value stores, and document-oriented storage systems.

The term “structured data” refers to data stored in a defined format with explicit fields, identifiers, and relationships, enabling efficient querying, indexing, and association between history information records, interview question information, interview record documents, and emotional time-series information.

The term “generation result” refers to an output produced by a generative AI model in response to a prompt sentence, including interview question information, summary information, feedback information, or additional interview question information.

In one embodiment, a server, a terminal, and a user cooperate to implement the interview-support system. The server comprises at least one processor, a main memory, a nonvolatile storage device, and a network interface, and may be realized on a general-purpose computing platform such as a rack-mounted server or a virtual machine instance. The terminal comprises a processor, a memory, a display, an acoustic sensor, and optionally an imaging apparatus, and may be realized as a smartphone, a tablet, a notebook computer, or a dedicated client device.

The server stores computer programs that implement optical character recognition, natural language processing, emotion analysis, and interaction with a generative AI model. In one embodiment, the server installs OCR software compatible with Tesseract OCR, a text processing stack compatible with a natural language processing library such as spaCy or an equivalent toolkit, an emotion analysis engine that uses audio-feature extractors compatible with OpenSMILE and text-based sentiment analysis libraries comparable to those in general-purpose cloud services, and an API client for a generative AI model such as a transformer-based large language model.

The terminal executes an application that displays interview questions, captures image data and audio data, and sends such data to the server. The terminal uses an imaging apparatus such as a flatbed scanner, a digital camera module, or a camera integrated in a mobile device to obtain visual information of history information records, and uses an acoustic sensor such as a built-in microphone or a wired or wireless headset to obtain audio information of conversations during interviews. The user operates the terminal by, for example, selecting a candidate, initiating a capture operation, and reviewing generated questions and interview records.

The server receives visual information of history information records, such as resumes and work-history documents, from the terminal via a network interface. The server stores the received image data in a storage area as raster image files along with metadata including a candidate identifier. The server executes optical character recognition processing on each file. In one embodiment, the server loads the image into memory, performs pre-processing such as grayscale conversion, binarization, and skew correction, and calls an OCR engine to generate a sequence of character codes and bounding boxes. The server converts the OCR result into text information encoded in a standard character set and preserves layout structure as markup or as position tags.

The server executes natural language processing on the text information. The server tokenizes the text into sentences and words, assigns part-of-speech tags, and runs a named-entity recognition model to detect organization names, job titles, dates, locations, and technology terms. In one embodiment, the server uses a neural network for named-entity recognition that includes an embedding layer, one or more bidirectional recurrent layers, and a classification layer with a softmax output. The server applies rule-based segmenters to separate sections corresponding to education, employment history, and skills. The server constructs affiliation organization information, duty information, and skill information by mapping recognized entities and phrases into a predefined data structure, for example, a JSON-like object or relational tuples with fields for organization type, size, role, time period, and skill category.

The server stores the structured data in an information storage apparatus, such as a relational database or a document store. The server assigns a unique identifier to each history information record, and associates that identifier with affiliation organization information, duty information, and skill information. The server also creates indexes on frequently used fields, such as industry type and skill keywords, to enable fast retrieval. This structured data representation reduces redundant parsing in subsequent operations and improves cache locality in memory, thereby improving processing speed when generating questions and summaries.

The server analyzes the structured data to identify items to be confirmed in an interview. The server executes a topic-extraction module that clusters responsibilities and skills into topics such as “project management,” “backend development,” or “customer interaction,” for example by computing document embeddings and applying a clustering algorithm. The server also executes a gap-detection module, which performs rule-based comparison of roles and durations to detect unusual patterns, such as short tenures or frequent job changes. The server records the identified items to be confirmed as part of structured metadata.

The server generates a first prompt sentence for a generative AI model. The server assembles a text string that includes affiliation organization information, duty information, skill information, and items to be confirmed in an interview. For example, the server may construct a prompt sentence such as:

“Candidate worked as a project manager in an IT company for 5 years, leading agile teams and handling stakeholder communication. Generate behavioral interview questions focusing on problem-solving, risk management, and team leadership.”

In another example, the server may construct:

“Based on the following work history, generate detailed behavioral interview questions focusing on project management and team leadership in an IT company: [extracted career text].”

The server transmits the prompt sentence to a generative AI model over a network. In one embodiment, the generative AI model is a transformer-based large language model having multiple self-attention layers, feed-forward layers, and a vocabulary embedding. The model parameters are trained in advance on large-scale corpora using an autoregressive language modeling objective. The server controls generation by specifying parameters such as temperature, maximum token length, and sampling strategy to obtain a list of interview question information. Because the prompt sentence is constructed from structured data, the generative AI model is guided to focus on relevant technical and behavioral aspects, thereby improving the precision and relevance of generated questions and reducing unnecessary tokens transmitted over the network.

The server post-processes the output of the generative AI model by segmenting it into individual questions, normalizing punctuation, and removing duplicates or off-topic items using a lightweight classifier that scores questions based on cosine similarity to topic vectors of the structured data. The server stores the resulting interview question information in the information storage apparatus, associated with the candidate identifier and the first prompt sentence used. The server then transmits the interview question information to the terminal.

The terminal receives the interview question information and displays it on the user-oriented display screen as a list of questions. The terminal allows the user to mark questions as asked, skipped, or high-priority, and logs such interactions. By managing questions as discrete entries rather than a single text blob, the terminal improves input responsiveness and enables partial synchronization with the server, reducing communication overhead.

During an interview, the terminal captures audio information via the acoustic sensor. The terminal samples the audio at a specified rate, for example 16 kHz, compresses it with an audio codec, and streams it to the server. The server buffers the incoming audio data in short segments and performs speech recognition processing. In one embodiment, the server sends the buffered segments to a speech recognition engine that uses an acoustic model implemented as a deep neural network and a language model to output text information. The server receives partial and final hypotheses, and commits final segments to storage as they stabilize.

The server executes emotion analysis processing on the basis of at least one of the audio information and the text information. For acoustic-based emotion analysis, the server extracts features such as pitch, energy, spectral centroid, and Mel-frequency cepstral coefficients using a feature-extraction module. The server inputs these features into a neural network classifier, which may have a convolutional front-end and a recurrent or transformer-based temporal layer followed by a softmax output layer that produces probabilities over emotion categories. For text-based emotion analysis, the server encodes the text information using a sentence-embedding model and applies a classifier to determine emotional valence and arousal. The server combines the acoustic-based and text-based outputs using a weighted fusion rule to estimate an emotional state, and stores emotion labels and confidence scores with timestamps as emotional time-series information.

The server generates a second prompt sentence for the generative AI model using emotional time-series information and interview question information. In one embodiment, the server identifies time intervals where negative or high-arousal emotions persist, or where emotion changes sharply in response to particular questions. The server constructs a prompt sentence that describes the situation and requests appropriate feedback or follow-up questions. For example, the server may generate:

“During the last question, the candidate's emotion changed to nervousness. Suggest two brief, supportive follow-up questions the interviewer can ask to help the candidate relax while still gathering useful information.”

The server sends the second prompt sentence to the generative AI model, receives generated text representing feedback information or additional interview question information, and transmits the result to the terminal. The terminal displays the feedback information discreetly, for example as a small notification at the edge of the screen. By computing the second prompt sentence automatically from emotional time-series information, and by integrating the generative AI model into this loop, the system reduces the cognitive load on the user and also reduces network usage by limiting prompt sentences to context segments where feedback is actually needed.

The server automatically generates an interview record document based on text information and emotional time-series information. The server concatenates recognized speech segments, preserving speaker labels and timestamps, and organizes them according to the original interview question information. The server identifies key segments based on a combination of factors such as question type, length of response, and emotion intensity. The server generates a third prompt sentence for the generative AI model to summarize the entire interview or specific sections. An example of such a prompt sentence is:

“Summarize the following interview transcript into clear minutes with sections: candidate background, major questions, key answers, and any notable emotional reactions. Emphasize points relevant to project management and leadership. Transcript: [transcript text].”

The server invokes the generative AI model with the third prompt sentence, obtains a summarized draft, and merges it with structured metadata. The server stores the interview record document and links it to the candidate identifier and the corresponding emotional time-series information. The server may export the interview record document as a structured format and as a human-readable document such as a portable document.

The server also analyzes interview record documents and emotional time-series information to support subsequent interviews. The server compares the topics covered during the interview with items to be confirmed derived from the structured data, and identifies items that were not sufficiently confirmed. The server then constructs another prompt sentence such as:

“Based on the resume and the previous interview transcript, identify three follow-up questions that the interviewer should ask in a second round, focusing on leadership and conflict resolution.”

By sending such a prompt sentence to the generative AI model, the server obtains additional interview question information optimized for the next session, without re-running the entire analysis pipeline. This reuse of structured data and cached embeddings reduces computational cost and improves overall throughput when many candidates are processed concurrently.

The server improves computer technology in several ways. First, by converting unstructured visual information and audio information into structured data and emotional time-series information with consistent identifiers and indexes, the server allows queries and updates to be executed using efficient database operations rather than ad-hoc text search, thereby reducing CPU cycles and memory usage per query. Second, by using prompt sentences that are dynamically constructed from structured data and emotion context, the server reduces the length and redundancy of requests to the generative AI model, lowering network bandwidth and latency compared to naive use of full transcripts or raw documents. Third, by integrating OCR, natural language processing, speech recognition, emotion analysis, and generative AI in a coordinated pipeline, the server minimizes repeated parsing and tokenization, and reuses intermediate embeddings and extracted features across modules, improving overall throughput.

The server implements the emotion analysis and prompt construction modules in a way that differs from human decision-making, using numerical features, high-dimensional embeddings, and rule-based fusion of model outputs. For example, the server may compute a moving average of emotion probabilities over a sliding window and trigger second prompt sentence generation only when a threshold on the derivative of emotional intensity is exceeded. This non-conventional rule reduces unnecessary prompts and stabilizes feedback timing, producing a measurable reduction in prompt calls and model invocations.

The server trains the neural networks used for emotion analysis and topic detection as follows. The server uses a training dataset of labeled audio and transcripts, computes features, and defines a loss function such as cross-entropy between predicted and true emotion labels. The server updates network weights using gradient descent with a learning-rate schedule and regularization, and may apply data augmentation to audio signals (for example, noise addition and pitch shifting) to improve robustness. For topic detection, the server may fine-tune a pre-trained transformer encoder on a supervised classification task to map text segments to topic labels. By disclosing these training methods, an implementer can reproduce the models and integrate them into the system.

In alternative embodiments, the terminal may perform part of the processing locally, such as on-device OCR for small documents or on-device feature extraction from audio, and transmit only text information or compressed features to the server. This reduces communication load and provides improved privacy while still allowing the server to execute heavier natural language processing, emotion analysis, and generative AI interactions. In another embodiment, the server may be implemented as a cluster of machines with a load balancer that routes OCR and speech recognition tasks to nodes optimized with hardware accelerators, and routes generative AI calls to a dedicated node that maintains persistent connections to a model serving infrastructure.

In another embodiment, the same architecture is applied to scenarios outside of hiring interviews, such as conversations in a vehicle or in a physical store. The server still performs OCR-based structuring of history information records, but the audio-information pipeline supports logging of in-vehicle instructions or customer-staff interactions, with emotional time-series information used to adjust environmental controls. For example, the terminal in a vehicle may send emotion labels to a local controller that adjusts lighting color or audio volume according to stress levels. In this case, the generative AI model may generate suggestions such as:

“Given that the passenger appears uncertain and slightly anxious about product reliability, generate three supportive phrases a clerk can use to reassure the customer.”

By directly influencing device control and environment configuration in response to computed emotional states and generative prompts, the system further demonstrates a technical use beyond mere information display.

Through these embodiments, the server, the terminal, and the user cooperate to execute a sequence of tightly integrated data transformations—starting from visual information and audio information, through structured data and emotional time-series information, to generative outputs—implemented by specific software modules and data structures. Because the architecture reduces duplicate computation, improves data locality and caching, and tailors generative AI invocations to compact, context-rich prompt sentences, the system achieves measurable improvements in processing speed, accuracy of question generation and emotion estimation, storage efficiency, and communication overhead compared to conventional architectures that treat each component in isolation.

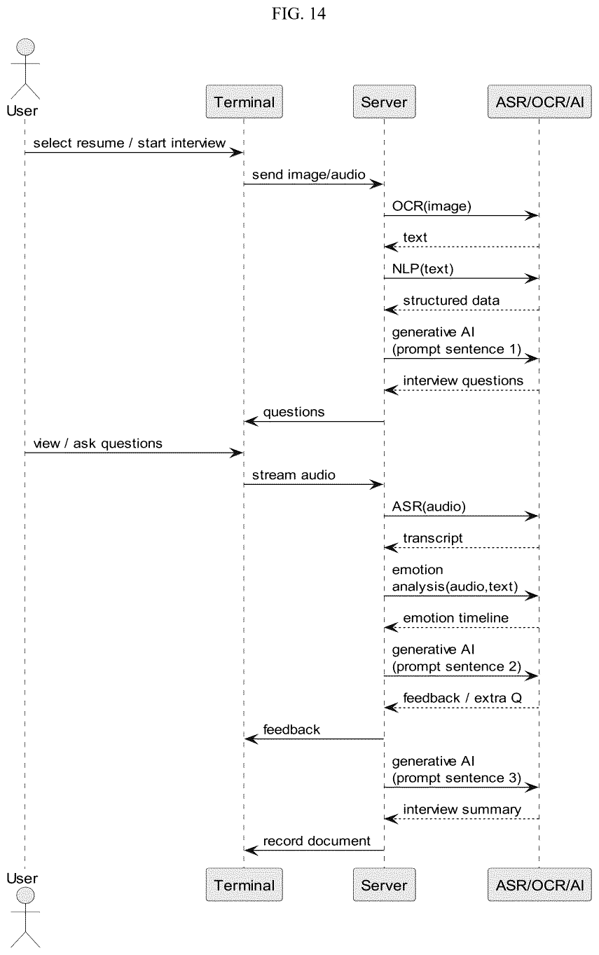

The following describes the processing flow using FIG. 14.

### Step 1

User provides history information records to the system.

User operates the terminal to select one or more history information records, such as resumes or work-history documents, and initiates a capture operation. The input in this step is physical or digital documents containing printed or handwritten text. User either places paper documents on a scanner, points a camera at the documents, or selects existing image or PDF files stored on the terminal. The output of this step is a set of digital files (for example, JPEG, PNG, or PDF) ready to be transmitted to the server.

### Step 2

Terminal captures and transmits visual information to the server.

Terminal uses an imaging apparatus, such as an integrated camera or a connected scanner, to capture visual information of the history information records. The input is the physical document or selected file path; the terminal converts this into raster image data and assigns local identifiers. Terminal packages the image data and metadata (for example, candidate name, capture time) into a request and transmits it to the server over a network connection using a secure protocol. The output of this step is a message containing image data and metadata received by the server.

### Step 3

Server performs optical character recognition and basic text normalization.

Server receives the visual information from the terminal. The input is the image data and associated metadata. Server loads the image into memory, performs pre-processing such as grayscale conversion, noise reduction, and skew correction, and invokes an OCR engine to analyze pixel patterns and detect glyphs. Server converts detected glyphs into text information, including character codes and their positions, and normalizes encodings, removes obvious artifacts, and merges lines into coherent paragraphs. The output of this step is machine-readable text information representing the content of the history information records.

### Step 4

Server structures the recognized text into organized data fields.

Server processes the text information to create structured data. The input is the plain text with optional layout hints produced by OCR. Server applies natural language processing: tokenization, sentence segmentation, part-of-speech tagging, and named-entity recognition to locate organization names, job titles, time periods, locations, and skill terms. Server executes rule-based segmenters to separate sections such as “Education,” “Experience,” and “Skills.”

Server aggregates these elements into affiliation organization information, duty information, and skill information stored in predefined data structures. The output is structured data objects or records associated with each candidate identifier.

### Step 5

Server stores structured data and indexes it for efficient retrieval.

Server writes the structured data into an information storage apparatus. The input is the set of structured records created in Step 4. Server assigns unique identifiers to each history information record, creates relational or document-based entries, and generates indexes on frequently accessed fields such as organization type, role, and skill keywords. Server stores references linking the original image, the OCR text, and the structured data. The output of this step is a persistent, indexed database state that can be efficiently queried in later steps.

### Step 6

Server identifies items to be confirmed in an interview.

Server analyzes the structured data to determine items requiring further clarification. The input is the affiliation organization information, duty information, and skill information retrieved from the storage apparatus for a particular candidate. Server applies topic-detection algorithms to group duties and skills into topics, and applies rule sets to find gaps or anomalies, such as short tenure periods or rapid job changes. Server constructs a list of items to be confirmed in an interview, which may include missing details, unusual transitions, or critical achievements. The output is a structured list of items to be confirmed associated with the candidate.

### Step 7

Server constructs a first prompt sentence for the generative AI model.

Server uses the structured data and items to be confirmed to assemble a context-rich text instruction. The input is the affiliation organization information, duty information, skill information, and the list of items to be confirmed. Server formats these elements into a coherent narrative and explicit request, generating a prompt sentence that specifies the candidate background and the desired type of output. For example, server may produce: “Candidate worked as a project manager in an IT company for 5 years, leading agile teams and handling stakeholder communication. Generate behavioral interview questions focusing on problem-solving, risk management, and team leadership.” The output is a first prompt sentence ready to be input to the generative AI model.

### Step 8

Server invokes the generative AI model to obtain interview question information.

Server sends the first prompt sentence to a generative AI model via an API call. The input is the text of the first prompt sentence and generation parameters such as maximum output length and temperature. Server transmits this request to a model serving endpoint and waits for a response. The generative AI model returns generated text that includes one or more interview questions. Server parses the raw output, splits it into individual questions, removes noise or off-topic lines, and converts the questions into structured interview question information associated with the candidate. The output is a cleaned and structured set of interview questions stored in server memory.

### Step 9

Server stores interview question information and delivers it to the terminal.

Server persists the generated interview question information in the information storage apparatus. The input is the structured list of questions returned from Step 8. Server tags each question with a candidate identifier, question index, and timestamp. Server then creates a response message containing the interview question information and transmits it to the terminal. The output is both a stored record of questions in the database and a network response received by the terminal.

### Step 10

Terminal presents interview questions to the user and logs interactions.

Terminal receives the interview question information from the server. The input is the list of structured questions. Terminal renders the questions on a user-oriented display screen as a scrollable list, allows the user to select a question, mark it as asked or skipped, and adjust the order if desired. Terminal records these interactions as logs, including which questions were displayed and at what time. The output is a visual presentation of questions to the user and an interaction log that can later be sent back to the server.

### Step 11

User conducts the interview while viewing questions on the terminal.

User reads the displayed interview questions on the terminal and verbally asks them to the candidate. The input, from the user's perspective, is the set of questions shown on the screen and any feedback notifications. User chooses which questions to ask, may improvise additional questions, and proceeds through the interview. The output of this step is spoken dialogue between the user and the candidate, which is captured as audio information by the terminal.

### Step 12

Terminal captures and streams interview audio to the server.

Terminal uses the acoustic sensor to record the dialogue between the user and the candidate. The input is the raw analog sound signals in the environment. Terminal converts these signals into digital audio samples at a specified sampling rate, applies compression with an audio codec, and attaches metadata such as candidate identifier and timestamps. Terminal then streams the compressed audio data to the server over a secure channel. The output is a continuous sequence of audio data packets received by the server.

### Step 13

Server performs speech recognition to generate text information.

Server receives the audio data streamed from the terminal. The input is the sequence of compressed audio packets with metadata. Server decodes the audio, segments it into analysis windows, and sends these segments to a speech recognition engine. The speech engine returns hypothesized text for each segment. Server merges segments, corrects obvious recognition errors based on domain-specific vocabularies, and aligns text with timestamps. The output of this step is text information representing the interview conversation.

### Step 14

Server performs emotion analysis and builds emotional time-series information.

Server analyzes the audio and text to estimate emotional states. The input is the text information from speech recognition and optionally the intermediate audio features. Server extracts acoustic features such as pitch and energy from the audio, and computes text embeddings or sentiment scores from the text. Server feeds these features into an emotion classification model to produce emotion labels and confidence values over time. Server aggregates these outputs into emotional time-series information with timestamps indicating how the emotional state changes during the interview. The output is structured emotional time-series data associated with the session.

### Step 15

Server constructs a second prompt sentence for feedback or follow-up questions.

Server examines the emotional time-series information together with the interview question information. The input is the emotion data over time and the sequence of questions that were displayed or asked. Server identifies intervals where particular questions correlate with strong emotional responses, such as increased nervousness or enthusiasm. Server then composes a second prompt sentence describing this context and requests either feedback for the interviewer or additional interview questions. For example, server may generate: “During the last question, the candidate's emotion changed to nervousness. Suggest two brief, supportive follow-up questions the interviewer can ask to help the candidate relax while still gathering useful information.” The output is the second prompt sentence customized for the current interview context.

### Step 16

Server calls the generative AI model to obtain feedback information or additional questions.

Server provides the second prompt sentence to the generative AI model. The input is the text of the second prompt sentence and associated generation parameters. Server receives generated text, such as suggested follow-up questions or advisory statements for the interviewer. Server parses the text, converts it into structured feedback information or additional interview question information, and filters out any unsuitable content. The output is a set of feedback messages or extra questions ready to be delivered to the terminal.

### Step 17

Terminal displays feedback information during the interview.

Terminal obtains the feedback information from the server. The input is the structured feedback or additional questions generated in Step 16. Terminal renders a compact notification or overlay on the user-oriented display screen, indicating, for example, that the candidate appears nervous and suggesting specific follow-up questions. Terminal logs when the feedback is shown and whether the user interacts with it. The output is visual feedback delivered to the user and an associated log that can later be analyzed.

### Step 18

Server generates an interview record document combining transcript and emotion data.

Server uses the text information and emotional time-series information to create a comprehensive record. The input is the recognized transcript with timestamps and speaker markers, the emotional time-series data, and optionally the list of questions that were asked. Server organizes the transcript into sections, identifies key exchanges, and associates emotion states with corresponding portions of the dialogue. Server assembles this information into a structured representation suitable for summary and archiving. The output is an intermediate data structure representing the interview record.

### Step 19

Server constructs a third prompt sentence for summarizing the interview.

Server prepares a request to the generative AI model to summarize the interview. The input is the intermediate interview record structure, including the transcript and selected emotion annotations. Server generates a third prompt sentence that specifies the desired summary sections and emphasis. For example, server may produce: “Summarize the following interview transcript into clear minutes with sections: candidate background, major questions, key answers, and any notable emotional reactions. Emphasize points relevant to project management and leadership. Transcript: [transcript text].” The output is the third prompt sentence that encodes the summarization task.

### Step 20

Server obtains summarized minutes from the generative AI model and stores the final record.

Server sends the third prompt sentence to the generative AI model. The input is the summarization prompt and relevant transcript content. Server receives generated summary text, aligns it with the underlying structured data, and formats it into an interview record document. Server then stores this document, along with links to the original transcript and emotional time-series information, in the recording information storage unit. The output is a finalized interview record document available for later review.

### Step 21

User reviews and optionally corrects the interview record via the terminal.

User accesses the interview record document after the session. The input is the stored record retrieved by the terminal from the server. User reads the summarized minutes and, if necessary, opens the detailed transcript to verify accuracy. User may correct misrecognized words or add clarifying notes using a text-editing interface on the terminal. The output of this step is an updated interview record document, which the terminal sends back to the server for replacement or versioned storage.

### Step 22

Server generates follow-up interview questions for future sessions.

Server analyzes the completed interview record and the emotional time-series information to discover topics that were insufficiently addressed. The input is the updated record and emotion data from prior steps. Server identifies items not fully explored and constructs a new prompt for the generative AI model, such as: “Based on the resume and the previous interview transcript, identify three follow-up questions that the interviewer should ask in a second round, focusing on leadership and conflict resolution.” Server sends this prompt to the generative AI model, receives additional interview question information, and stores it as a follow-up list. The output is a set of follow-up questions associated with the candidate and available for the next interview.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

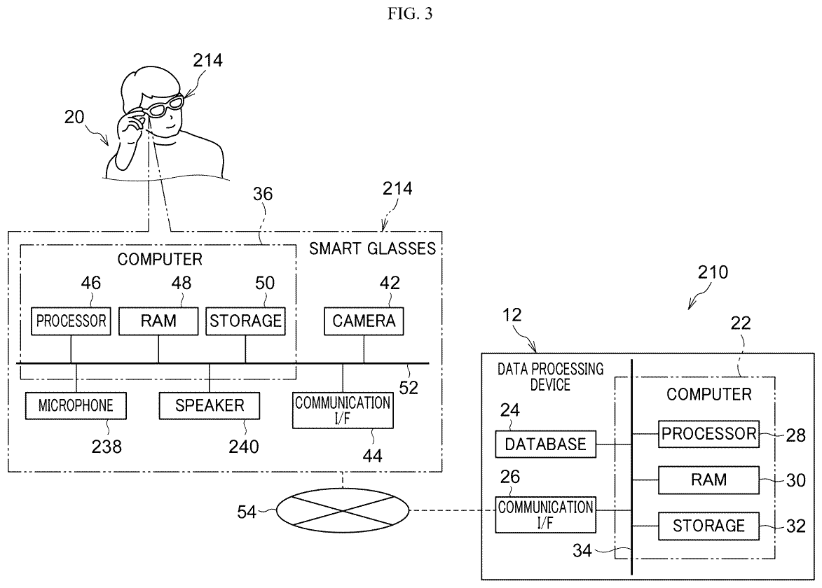

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

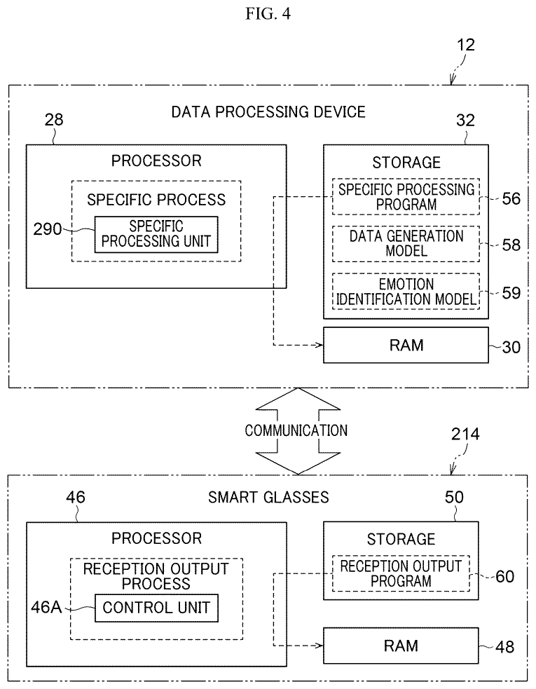

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

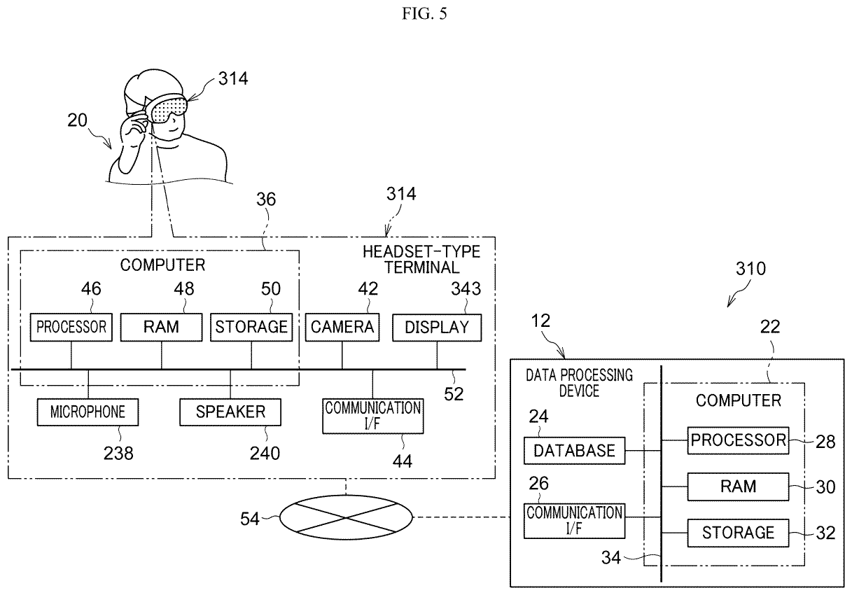

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

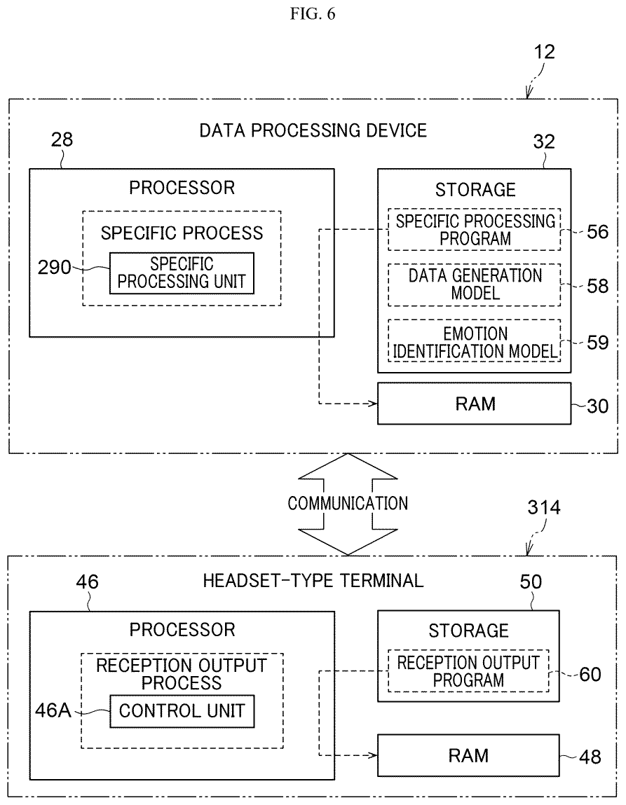

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

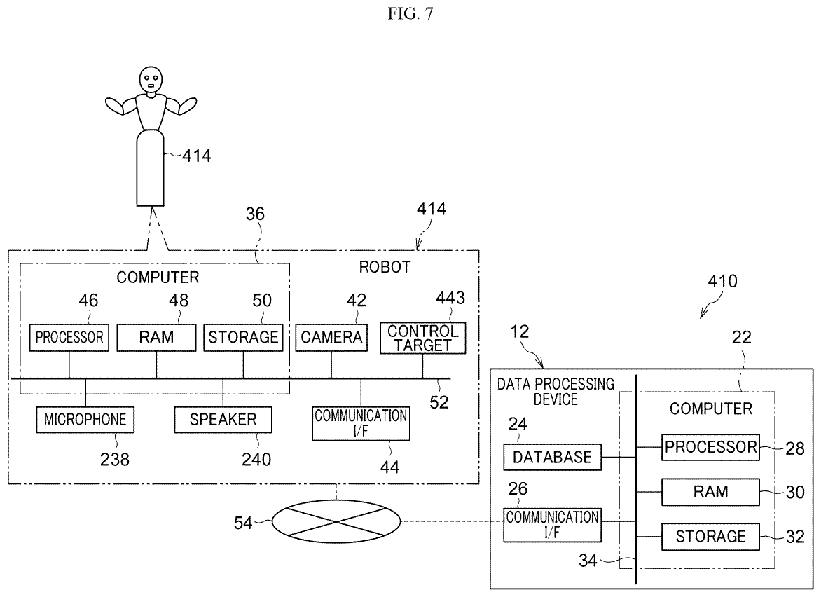

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

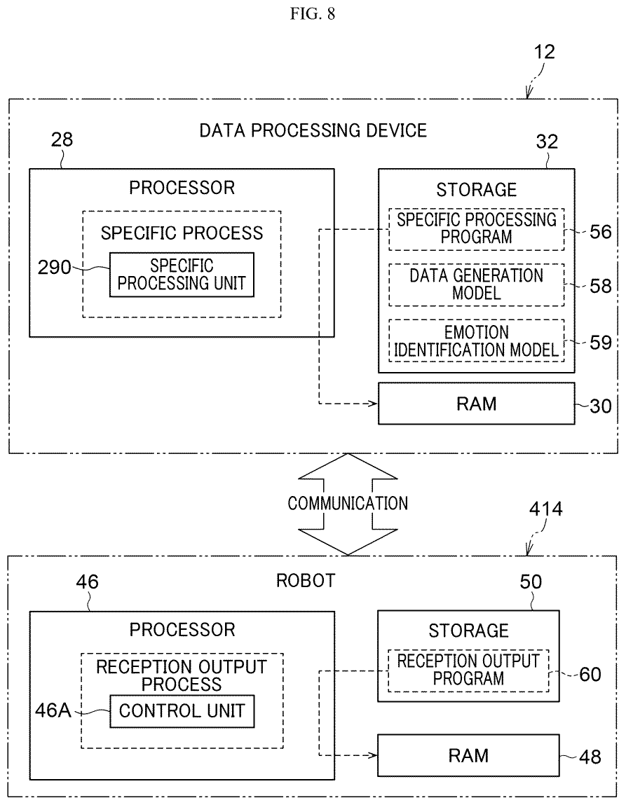

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

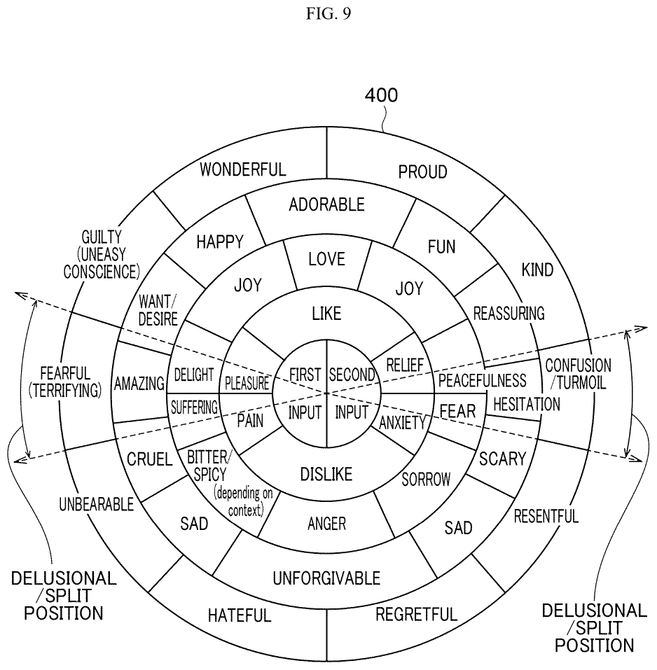

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

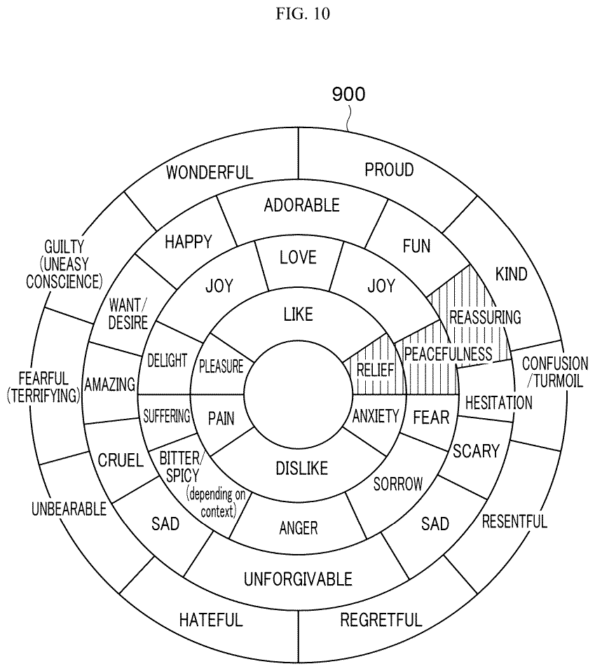

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire image data of a document including biography information and work history information via an image input device,
perform preprocessing and character recognition processing on the image data by using image processing software and an optical character recognition engine to extract character information in the document as digital text data,
execute text formatting processing and item identification processing on the digital text data, the text formatting processing including removal of unnecessary blanks and line breaks, so as to generate structured data in which the digital text data is divided into attributes including personal identification information, contact information, work history information, educational history information, and skill information, and store the structured data in an information management region of a data storage device,
execute prompt generation logic to generate a prompt sentence based on the structured data in order to cause a generative artificial intelligence model to perform summarization or evaluation of candidate history information, and provide to the generative artificial intelligence model input information including the prompt sentence and related structured data so that the generative artificial intelligence model generates a summary text or an evaluation text regarding a candidate,
store the summary text or the evaluation text output from the generative artificial intelligence model in association with the structured data in the information management region, and
provide the summary text or the evaluation text to a terminal device via a display interface, and
convert audio data acquired during or after an interview into text data by using an audio input device and a speech recognition engine, automatically generate interview content record data based on the text data, and perform generation of a prompt sentence and generation of a summary by the generative artificial intelligence model with respect to text information including the interview content record data.

### Supplementary 2

The system according to supplementary 1,
wherein the processor is configured to dynamically generate the prompt sentence by the prompt generation logic based on work history information, skill information, experience duration information, and job category information extracted from the structured data, the prompt sentence including a summarization target, skills to be emphasized, an output format, and a length condition, and input the prompt sentence to the generative artificial intelligence model.

### Supplementary 3

The system according to supplementary 1,
wherein the processor is configured to generate, for the text information including the interview content record data, a prompt sentence including evaluation viewpoint information and output section information, cause the generative artificial intelligence model to automatically generate interview report data including skill evaluation information, positive impression information, concern information, and recommended action information, and store and display the interview report data in association with candidate management information.

### Application Example 1

### Supplementary 1

A system comprising a processor,
wherein the processor is configured to
collect image information representing personal history information and work history information by using an image capturing device,
execute image processing on the image information to generate processed image information with improved accuracy for character recognition processing, and apply optical character recognition processing to the processed image information to extract character information as text information,
apply natural language processing to the text information to generate structured information including ability information and experience information of an applicant,
calculate suitability information of the applicant based on the structured information and requirement information on an organization side,
generate a prompt sentence for causing a generative information processing model to generate evaluation explanation information and question candidate information, the prompt sentence including evaluation target information comprising the structured information and the requirement information, and input the prompt sentence into the generative information processing model to obtain the evaluation explanation information and the question candidate information,
convert audio information acquired during an interview into text information by speech recognition processing, generate a prompt sentence for causing the generative information processing model to generate interview record information using the text information as input information, and input the prompt sentence into the generative information processing model to obtain the interview record information, and
provide the suitability information, the evaluation explanation information, the question candidate information, and the interview record information as output information to a user terminal.

### Supplementary 2

The system according to supplementary 1,
wherein the processor is configured to
format the text information and the structured information into a predetermined information structure, store the formatted information in an information storage device, and manage the suitability information, the evaluation explanation information, the question candidate information, and the interview record information in association with the formatted information.

### Supplementary 3

The system according to supplementary 1,
wherein the processor is configured to
receive the image information representing the personal history information and the work history information and the audio information acquired during the interview from the user terminal, and transmit display information for display control including the question candidate information and the interview record information to the user terminal.

### Example 2

### Supplementary 1

A system comprising a processor,
wherein the processor is configured to
acquire document data including applicant career information from an image acquisition device or an information processing terminal,
extract character information from the acquired document data by using optical character recognition technology or document analysis technology and convert the extracted character information into digital text data,
apply natural language processing technology to the converted digital text data to extract organization attribute information and work history information of the applicant and generate structured information including the organization attribute information and the work history information,
generate a prompt sentence for causing a generative AI model to generate question information including matters to be confirmed in an interview based on the structured information, and input the prompt sentence into the generative AI model to obtain output information including the question information,
transmit the obtained question information to the information processing terminal and cause the information processing terminal to present the question information as an interview preparation question list, and
convert audio data acquired during the interview into text data by using speech recognition technology and automatically generate interview record information from the text data by using natural language processing technology or the generative AI model.

### Supplementary 2

The system according to supplementary 1,
wherein the processor is configured to
format the extracted character information into a predetermined format, and store, as structured data in a storage device of a data management apparatus, the organization attribute information, the work history information, the question information, and the interview record information.

### Supplementary 3

The system according to supplementary 1,
wherein the processor is configured to
generate a prompt sentence for causing the generative AI model to generate summary information including at least a part of the organization attribute information and the work history information extracted by the natural language processing technology, input the prompt sentence into the generative AI model to obtain the summary information, and store the summary information in association with the question information or the interview record information.

### Application Example 2

### Supplementary 1

A system comprising a processor,
wherein the processor is configured to
acquire visual information including image data of history information records by using an imaging apparatus,
convert character information included in the visual information into text information by performing optical character recognition processing,
analyze the text information by natural language processing to extract affiliation organization information, duty information, and skill information, and identify items to be confirmed in an interview on the basis of an extraction result,
generate a prompt sentence to be input to a generative AI model on the basis of the affiliation organization information, the duty information, the skill information, and the items to be confirmed in the interview, and input the prompt sentence to the generative AI model so as to cause the generative AI model to generate interview question information or summary information,
transmit the interview question information to a terminal device and cause a user-oriented display screen on the terminal device to present the interview question information, acquire audio information of conversation speech in the interview from an acoustic sensor and convert the audio information into text information by speech recognition processing,
execute emotion analysis processing on the basis of at least one of the audio information and the text information to estimate an emotional state and generate emotional time-series information indicating a temporal change of the emotional state,
generate a prompt sentence for generating feedback information for an interviewer or additional interview question information for further input on the basis of the emotional time-series information and the interview question information, and input the prompt sentence to the generative AI model so as to cause the generative AI model to generate the feedback information or the additional interview question information, and
automatically generate an interview record document on the basis of the text information and the emotional time-series information and store the interview record document in a recording information storage unit.

### Supplementary 2

The system according to supplementary 1,
wherein the processor is configured to
format the text information and the extracted affiliation organization information, duty information, and skill information into a predetermined data format, assign an identifier to the formatted data, store the formatted data as structured data in an information storage apparatus, and manage the structured data in association with the interview question information, the interview record document, and the emotional time-series information.

### Supplementary 3

The system according to supplementary 1,
wherein the processor is configured to
analyze the interview record document and the emotional time-series information, identify items that were not sufficiently confirmed during the interview, generate a prompt sentence for generating additional interview question information for a subsequent interview on the basis of the identified items, input the prompt sentence to the generative AI model so as to cause the generative AI model to generate the additional interview question information, and
provide a generation result to the terminal device.

What is claimed is:

1. A system comprising:
circuitry configured to:
acquire image data of a document via an image input device;
perform image preprocessing and optical character recognition processing on the image data to extract character information as digital text data;
apply a natural language processing algorithm to the digital text data to generate structured data in which the digital text data is divided into a plurality of attribute categories;
store the structured data in a storage medium;
construct a parameterized instruction sequence based on the structured data, the parameterized instruction sequence specifying a summarization task for a generative neural network model; and
provide the parameterized instruction sequence to the generative neural network model to cause the generative neural network model to generate summary text data based on the structured data.

2. The system according to claim 1, wherein the image preprocessing comprises at least one of noise reduction processing, contrast adjustment processing, binarization processing, and skew correction processing applied to the image data prior to the optical character recognition processing.

3. The system according to claim 2, wherein the text formatting processing includes removal of unnecessary blank characters and line break characters from the digital text data, and wherein the plurality of attribute categories include identification information, contact information, organizational history information, educational history information, and skill information.

4. The system according to claim 3, wherein the circuitry is further configured to:
execute item identification processing on the digital text data by detecting predetermined delimiter patterns and section header patterns within the digital text data to assign portions of the digital text data to corresponding attribute categories.

5. The system according to claim 4, wherein the circuitry is further configured to:
dynamically generate the parameterized instruction sequence based on organizational history information, skill information, experience duration information, and category information extracted from the structured data, the parameterized instruction sequence including a summarization target specification, emphasis attribute identifiers, an output format specification, and a length condition.

6. The system according to claim 5, wherein the circuitry is further configured to:
calculate relevance score data for the entity based on the structured data and requirement condition data stored in the storage medium, and incorporate the relevance score data into the parameterized instruction sequence to cause the generative neural network model to generate evaluation explanation data and inquiry candidate data.

7. The system according to claim 6, wherein the relevance score data is calculated by computing vector representations of the skill information and the requirement condition data using an embedding model, and calculating a similarity score between the vector representations using a distance metric.

8. The system according to claim 7, wherein the circuitry is further configured to:
convert audio data acquired via an acoustic transducer into text data by executing a speech recognition algorithm on the audio data, and generate record data based on the converted text data.

9. The system according to claim 8, wherein the circuitry is further configured to:
construct a secondary parameterized instruction sequence based on the record data, the secondary parameterized instruction sequence specifying a structured summarization task for the generative neural network model, and provide the secondary parameterized instruction sequence to the generative neural network model to generate structured record summary data.

10. The system according to claim 9, wherein the structured record summary data includes skill evaluation information, positive attribute information, concern information, and recommended action information, and wherein the circuitry stores the structured record summary data in association with entity management information in the storage medium.

11. The system according to claim 9, wherein the secondary parameterized instruction sequence includes evaluation viewpoint information specifying a plurality of evaluation dimensions and output section information specifying a plurality of output sections, such that the generative neural network model generates the structured record summary data organized according to the plurality of output sections.

12. The system according to claim 5, wherein the generative neural network model comprises a transformer-based architecture including a plurality of self-attention layers, feed-forward layers, and normalization layers, and wherein the circuitry provides the parameterized instruction sequence as a token sequence to the transformer-based architecture together with decoding control parameters including a maximum output token count and a sampling temperature value.

13. The system according to claim 12, wherein the circuitry is further configured to:
apply named entity recognition processing to the digital text data to identify organization name entities, date entities, and role title entities, and map the identified entities to corresponding fields within the structured data.

14. The system according to claim 13, wherein the circuitry is further configured to:
extract, from the structured data, a chronological sequence of organizational history entries, compute duration values for each entry, and generate a timeline data structure associating each entry with a start date, an end date, and a role descriptor.

15. The system according to claim 14, wherein the circuitry is further configured to:
receive, from a terminal apparatus via a packet-switched network, requirement condition data specifying desired attribute values, and compare the structured data against the requirement condition data to generate a compatibility assessment data structure indicating matching attributes and non-matching attributes.

16. The system according to claim 15, wherein the circuitry is further configured to:
incorporate the compatibility assessment data structure into the parameterized instruction sequence to cause the generative neural network model to generate targeted inquiry data addressing the non-matching attributes identified in the compatibility assessment data structure.

17. The system according to claim 16, wherein the circuitry is further configured to:
transmit the summary text data, the relevance score data, the inquiry candidate data, and the structured record summary data to the terminal apparatus via the packet-switched network for display on a presentation interface of the terminal apparatus.

18. A system comprising:
circuitry configured to:
acquire, via an image input device coupled to a communication interface, image data of a document and perform optical character recognition processing on the image data to extract character information as digital text data;
apply a natural language processing algorithm to the digital text data to generate structured data divided into a plurality of attribute categories, and store the structured data in a storage medium;
construct a parameterized instruction sequence based on the structured data and requirement condition data stored in the storage medium, and provide the parameterized instruction sequence to a generative neural network model having a transformer-based architecture including a plurality of self-attention layers to generate summary text data and evaluation data;
convert audio data acquired via an acoustic transducer into text data by executing a speech recognition algorithm, and construct a secondary parameterized instruction sequence based on the text data to cause the generative neural network model to generate structured record summary data; and
transmit the summary text data, the evaluation data, and the structured record summary data to a terminal apparatus via a packet-switched network.

19. The system according to claim 18, wherein the circuitry is further configured to:
calculate relevance score data by computing vector similarity between skill information extracted from the structured data and attribute values specified in the requirement condition data, and incorporate the relevance score data into the parameterized instruction sequence to cause the generative neural network model to generate evaluation explanation data and targeted inquiry data.

20. A method performed by circuitry, the method comprising:
acquiring image data of a document via an image input device;
performing image preprocessing and optical character recognition processing on the image data to extract character information as digital text data;
applying a natural language processing algorithm to the digital text data to generate structured data in which the digital text data is divided into a plurality of attribute categories;
storing the structured data in a storage medium;
constructing a parameterized instruction sequence based on the structured data, the parameterized instruction sequence specifying a summarization task for a generative neural network model; and
providing the parameterized instruction sequence to the generative neural network model to cause the generative neural network model to generate summary text data based on the structured data.
